(19) United States
(12) Patent Application Publication
(10) Pub. No.: US 2019/0199033 A1
(43) Pub. Date: Jun. 27, 2019

(54) RECEPTACLE UNIT

(71) Applicant: ACES ELECTRONICS CO., LTD., Zhongli City (TW)

(72) Inventors: Nobukazu KATO, Tokyo (JP); Hiroaki HASHIMOTO, Sagamihara-shi (JP)

(73) Assignee: ACES ELECTRONICS CO., LTD., Zhongli City (TW)

(21) Appl. No.: 16/287,278

(22) Filed: Feb. 27, 2019

Related U.S. Application Data
(62) Division of application No. 15/455,733, filed on Mar. 10, 2017, now Pat. No. 10,263,365.

(30) Foreign Application Priority Data
Mar. 15, 2016 (JP) 2016-050451
Oct. 7, 2016 (JP) 2016-198738

(51) Int. Cl. H01R 13/629; H01R 27/02

(52) U.S. Cl. CPC H01R 13/629; H01R 24/60; H01R 27/02

(57) ABSTRACT

There is provided a receptacle unit including a plurality of receptacle connectors and mounted on an electronic apparatus, at least two guide reception portions which, when docking with a plug unit including a plurality of plug connectors, before at least one of the plurality of receptacle connectors engages with at least one of the plurality of plug connectors, receiving a guide portion of the plug unit, and a coupling portion which couples the at least two guide reception portions, at least one receptacle connector of the plurality of receptacle connectors which is mounted on a board independently of at least one other of the receptacle connectors, and the at least two guide reception portions and the coupling portion which are fixed to the board after the plurality of receptacle connectors are mounted on the board.

### CROSS-REFERENCE TO RELATED APPLICATIONS

This application is a divisional of U.S. patent application Ser. No. 15/455,733, filed on Mar. 10, 2017, which claims priority to Japanese Patent Application No. 2016-050451, filed on Mar. 15, 2016, and Japanese Patent Application No. 2016-198738, filed on Oct. 7, 2016, the disclosures of which are herein incorporated by reference in their entirety.

### TECHNICAL FIELD

The present invention relates to a plug unit including a plurality of predetermined standard plug connectors, and a receptacle unit including a plurality of predetermined standard receptacle connectors.

### BACKGROUND ART

Portable terminal devices such as a tablet type PC and the like are used while being docked with peripheral equipment such as a keyboard, a mouse or the like in more and more cases. In such a case, in order to realize high-speed transmission, it is demanded to mount a docking connector including more contacts on a portable terminal device and peripheral equipment. For example, Patent Literature 1 recites a docking connector including a pair of connectors each having numerous contacts aligned, in which one connector is docked with the other connector.

### CITATION LIST

### Patent Literature

Patent Literature 1: JP H11-288760 A

### SUMMARY OF INVENTION

### Technical Problem

In the docking connector recited in JP H11-288760 A, one connector can be docked only with the other connector. Specifically, peripheral equipment with one connector mounted thereon can be docked with a portable terminal device with the other connector mounted thereon, but not with peripheral equipment mounted with other connector than the other connector.

Thus, use of a docking connector has been studied which includes two or more connectors conforming to the standard specification (hereinafter, referred to as a predetermined standard connector) such as the USB Type-C or the like. For example, a portable terminal device mounted with a receptacle side docking connector as a receptacle unit including two predetermined standard receptacle connectors can be docked not only with peripheral equipment mounted with a plug side docking connector as a plug unit including two predetermined standard plug connectors but also with peripheral equipment mounted with one predetermined standard plug connector. In other words, one of the two predetermined standard receptacle connectors provided in the receptacle side docking connector on the side of the portable terminal device can be docked with the peripheral equipment mounted with one predetermined standard plug connector. Further, the other of the two predetermined standard receptacle connectors provided in the above receptacle side docking connector can be connected with other peripheral equipment mounted with one predetermined standard plug connector as well.

However, in a step of assembling such a docking connector as described above, it is difficult to mount two predetermined standard connectors at an accurate position and in an accurate posture. When positions and postures of the two predetermined standard connectors deviate from each other during mounting, connection of the predetermined standard connector with a partner connector might develop a failure, or engagement of a predetermined standard connector with a partner connector might cause breakage.

Additionally, in order to realize higher speed transmission by increasing the number of contacts, it is demanded to mount an additional connector on a docking connector including two or more of such predetermined standard connectors as described above. However, mounting an additional connector increases a docking connector in size.

An object of the present invention is to provide a plug unit and a receptacle unit which enable a tolerance to be minimized and enable size reduction.

### Solution to Problem

A plug unit of the present invention includes a plurality of predetermined standard plug connectors, the predetermined standard plug connectors each including a contact that connects with a connection terminal of a predetermined standard receptacle connector, and the plug unit includes one insulator which holds the contact that each of the plurality of predetermined standard plug connectors has and which defines an interval between the plurality of predetermined standard plug connectors and a posture of the predetermined standard plug connectors.

Additionally, the plug unit of the present invention includes a guide portion to be inserted, when docking with a receptacle unit including the plurality of predetermined standard receptacle connectors, before the predetermined standard plug connectors engage with the predetermined standard receptacle connectors, into a guide insertion portion of the receptacle unit.

Additionally, in the plug unit of the present invention, the guide portion includes a first additional connector.

Additionally, the plug unit of the present invention includes a plurality of predetermined standard plug connectors, and a cover which covers the plurality of predetermined standard plug connectors, and the plug unit includes a guide portion to be inserted, when docking with a receptacle unit including a plurality of predetermined standard receptacle connectors, before the predetermined standard plug connectors engage with the plug unit, into a guide insertion portion of the receptacle unit, wherein the guide portion is formed integrally with the cover.

Additionally, in the plug unit of the present invention, the cover has an opening portion for exposing an engagement portion in which the predetermined standard plug connector engages with the predetermined standard receptacle connector, and between an outer wall portion of the predetermined standard plug connector and a wall portion forming the opening portion, a predetermined space is formed such that the predetermined standard plug connectors can move on a cross plane crossing an engagement direction of engagement with the predetermined standard receptacle connectors, and the plug unit includes a control portion which controls, relative to the opening portion, at least either one of a position and a posture of at least one of the predetermined standard plug connectors.

Additionally, in the plug unit of the present invention, the guide portion and the cover are formed of resin, and the guide portion has metal incorporated therein.

Additionally, the plug unit of the present invention includes a first additional connector arranged in the guide portion.

Additionally, a plug unit of the present invention, which is a plug unit including a plurality of predetermined standard plug connectors, includes a guide portion which is inserted into a guide insertion portion of a receptacle unit having a plurality of predetermined standard receptacle connectors when docking with the receptacle unit, before the predetermined standard plug connector engages with the predetermined standard receptacle connector, and includes a first additional connector arranged in the guide portion.

Additionally, in the plug unit of the present invention, the predetermined standard plug connectors include contacts to be connected with connection terminals of the predetermined standard receptacle connectors, and one insulator is provided which holds the contacts that the plurality of predetermined standard plug connectors respectively have and which defines respective intervals between the plurality of predetermined standard plug connectors and postures of the predetermined standard plug connectors.

Additionally, in the plug unit of the present invention, the guide portion is formed in the periphery of the predetermined standard plug connector.

Additionally, in the plug unit of the present invention, the guide portion is formed between the plurality of predetermined standard plug connectors.

Additionally, in the plug unit of the present invention, the guide portion is formed of metal.

Additionally, in the plug unit of the present invention, a width of the guide portion in a direction orthogonal to an alignment direction in which the plurality of predetermined standard plug connectors is aligned is not less than an internal diameter width of an internal diameter of the predetermined standard receptacle connector in the direction orthogonal to the alignment direction.

Additionally, in the plug unit of the present invention, the guide portion has an arrangement portion in which the first additional connector is arranged.

Additionally, in the plug unit of the present invention, the first additional connector includes a first contact having a connection surface which connects with a connection terminal of a second additional connector, and the connection surface of the first contact is arranged on a top surface of the guide portion.

Additionally, in the plug unit of the present invention, the plurality of predetermined standard plug connectors is a reversible connector.

Additionally, the plug unit of the present invention includes at least two first additional connectors, and the receptacle unit includes at least one second additional connector connectable with the one first additional connector and the other first additional connector.

Additionally, in the plug unit of the present invention, the predetermined standard plug connector is of USB Type-C.

A receptacle unit of the present invention includes a plurality of predetermined standard receptacle connectors and is mounted on an electronic apparatus, and includes at least one guide reception portion which, when docking with a plug unit including a plurality of predetermined standard plug connectors, before the predetermined standard receptacle connectors engage with the predetermined standard plug connectors, receives a guide portion of the plug unit, wherein at least one predetermined standard receptacle connector of the plurality of predetermined standard receptacle connectors is mounted on a board independently of at least one other of the predetermined standard receptacle connectors, when at least two of the guide reception portions are provided, the at least two guide reception portions are integrally formed, and the guide reception portion is fixed to the board after the predetermined standard receptacle connectors are mounted on the board.

Additionally, in the receptacle unit of the present invention, the guide reception portion includes a second additional connector.

Additionally, in the receptacle unit of the present invention, the second additional connector includes a second contact, one end portion of which second contact is electrically connected with a first contact of the first additional connector and the other end portion of which second contact is electrically connected with a wire.

Additionally, in the receptacle unit of the present invention, the second additional connector includes a first engagement portion which engages with the first additional connector, and a second engagement portion which engages with a connector mounted on the board.

Additionally, in the receptacle unit of the present invention, the guide reception portion covers the predetermined standard receptacle connectors, and the guide reception portion and a shell of the predetermined standard receptacle connectors electrically conduct with each other.

Additionally, in the receptacle unit of the present invention, the guide reception portion includes a fixing portion to be fixed to the board, the fixing portion being arranged in the vicinity of the second additional connector and between the plurality of predetermined standard receptacle connectors.

Additionally, in the receptacle unit of the present invention, the guide reception portion is fixed to a casing of the electronic apparatus together with the board.

Additionally, in the receptacle unit of the present invention, the predetermined standard receptacle connectors are mounted on a mounting surface of the board such that an engagement direction of engagement with the predetermined standard plug connectors is parallel to the mounting surface, and the guide reception portion is fixed to the board from a position opposed to the mounting surface.

Additionally, in the receptacle unit of the present invention, the guide reception portion supports the predetermined standard receptacle connector in an insertion direction in which the guide portion of the plug unit is inserted into the guide reception portion.

Additionally, in the receptacle unit of the present invention, the electronic apparatus is a portable terminal device.

Additionally, in the receptacle unit of the present invention, the predetermined standard receptacle connector is of USB Type-C.

Advantageous Effects of Invention

According to the present invention, a plug unit and a receptacle unit can be provided which enable a tolerance to be minimized and realize size reduction.

### BRIEF DESCRIPTION OF DRAWINGS

FIG. 1 is a perspective view showing an appearance of a plug docking connector according to a first embodiment;

FIG. 2 is an exploded view showing a configuration of two plug connectors that the plug docking connector according to the first embodiment has;

FIG. 3 is a view showing a configuration of a guide housing and an additional plug connector that the plug docking connector according to the first embodiment has;

FIG. 4 is a perspective view showing an appearance of a receptacle docking connector according to the first embodiment;

FIG. 5 is an exploded view showing a configuration of the receptacle docking connector according to the first embodiment;

FIG. 6 is a view showing a state where the plug docking connector and the receptacle docking connector according to the first embodiment are engaged with each other;

FIG. 7 is a view showing a configuration of other plug docking connector;

FIG. 8 is a view showing a configuration of other receptacle docking connector;

FIG. 9 is a perspective view showing an appearance of a plug docking connector according to a second embodiment;

FIG. 10 is a bottom plan view showing the appearance of the plug docking connector according to the second embodiment;

FIG. 11 is an exploded view showing a configuration of the plug docking connector according to the second embodiment;

FIG. 12 is a perspective view showing an appearance of a front cover according to the second embodiment;

FIG. 13 is a view showing a configuration of a control portion according to the second embodiment;

FIG. 14 is a sectional view showing a configuration of the plug docking connector according to the second embodiment;

FIG. 15 is a perspective view showing an appearance of a receptacle docking connector according to the second embodiment;

FIG. 16 is a front view showing the appearance of the receptacle docking connector according to the second embodiment;

FIG. 17 is a plan view showing the appearance of the receptacle docking connector according to the second embodiment;

FIG. 18 is a bottom plan view showing the appearance of the receptacle docking connector according to the second embodiment;

FIG. 19 is an exploded view showing a configuration of the receptacle docking connector according to the second embodiment;

FIG. 20 is an exploded view showing the configuration of the receptacle docking connector according to the second embodiment;

FIG. 21 is a sectional view showing the configuration of the receptacle docking connector according to the second embodiment;

FIG. 22 is a sectional view showing the configuration of the receptacle docking connector according to the second embodiment;

FIG. 23 is a perspective view showing an appearance of other plug docking connector;

FIG. 24 is a bottom plan view showing the appearance of other plug docking connector;

FIG. 25 is an exploded view showing a configuration of other plug docking connector;

FIG. 26 is a sectional view showing the configuration of other plug docking connector;

FIG. 27 is a perspective view showing an appearance of other receptacle docking connector;

FIG. 28 is a front view showing the appearance of other receptacle docking connector;

FIG. 29 is an exploded view showing a configuration of other receptacle docking connector; and

FIG. 30 is a sectional view showing the configuration of other receptacle docking connector.

### DESCRIPTION OF EMBODIMENTS

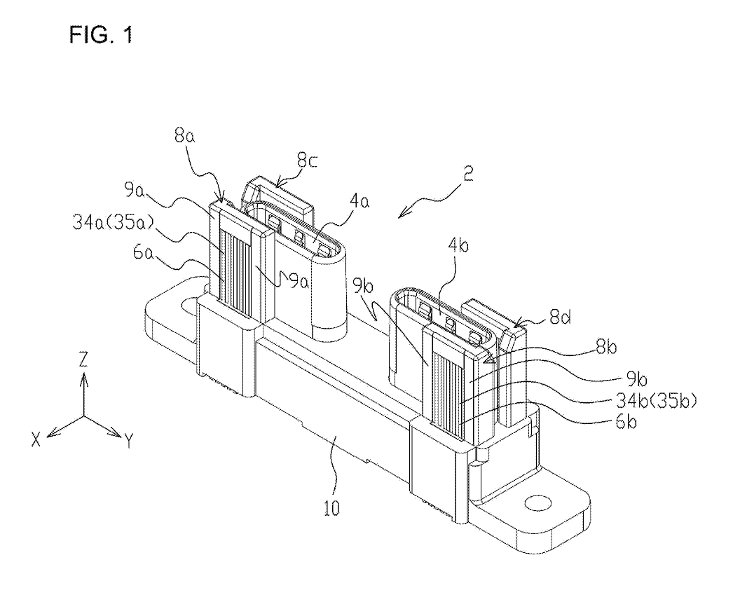

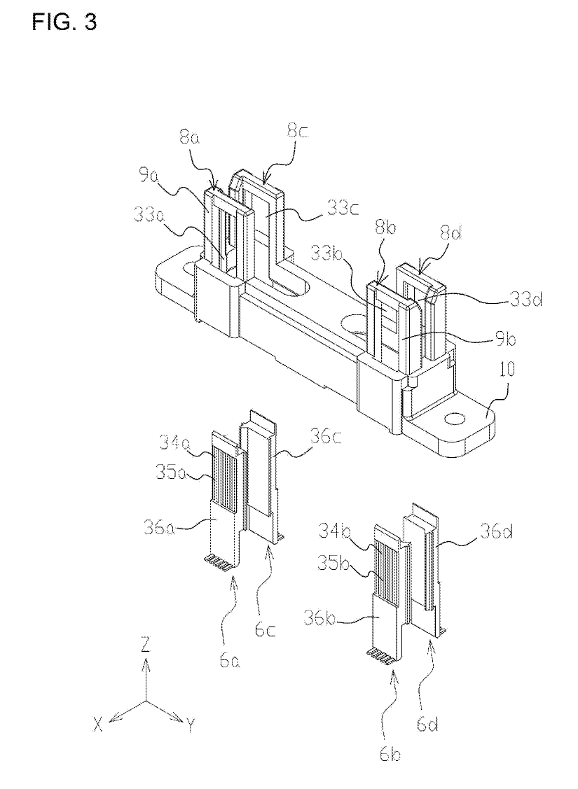

In the following, with reference to the drawings, a docking connector according to a first embodiment of the present invention will be described. FIG. 1 is a perspective view showing an appearance of a docking connector on a plug side (hereinafter, referred to as a plug docking connector) as a plug unit according to the first embodiment. As shown in FIG. 1, a plug docking connector 2 includes a guide housing 10 having two USB Type-C plug connectors (hereinafter, referred to simply as a plug connector)4a and 4b, four additional plug connectors 6a to 6d (for 6c and 6d, see FIG. 3), and four guides 8a to 8d. The docking connector is a connector for connecting a portable terminal device with an external apparatus, which represents, in a broad sense, such a docking connector as incorporated into an apparatus main body, as housed in a housing or the like and as connected with an apparatus via a cable or the like, or other.

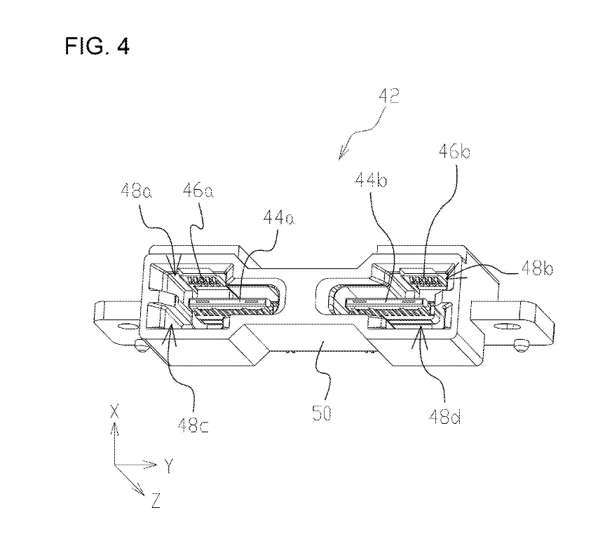

Additionally, in the following, with an XYZ orthogonal coordinate system set as shown in FIG. 1, description will be made of a positional relationship and the like of each member with reference to the orthogonal coordinate system. A Y axis is set to be parallel to a direction in which the two plug connectors 4a and 4b are arranged. A Z axis is set to be parallel to a direction in which the plug docking connector 2 is docked with a receptacle docking connector 42 (see FIG. 4). An X axis is set to be in a direction orthogonal to a YZ plane. Additionally, a side of the guides 8a and 8b is set to be a +X direction and a side of the guides 8c and 8d is set to be a −X direction, a side of the plug connector 4b is set to be a +Y direction and a side of the plug connector 4a is set to be a −Y direction, and a direction in which the plug docking connector 2 is docked with the receptacle docking connector 42 is set to be a +Z direction and a direction in which the plug docking connector 2 is pulled out from the receptacle docking connector 42 is set to be a −Z direction.

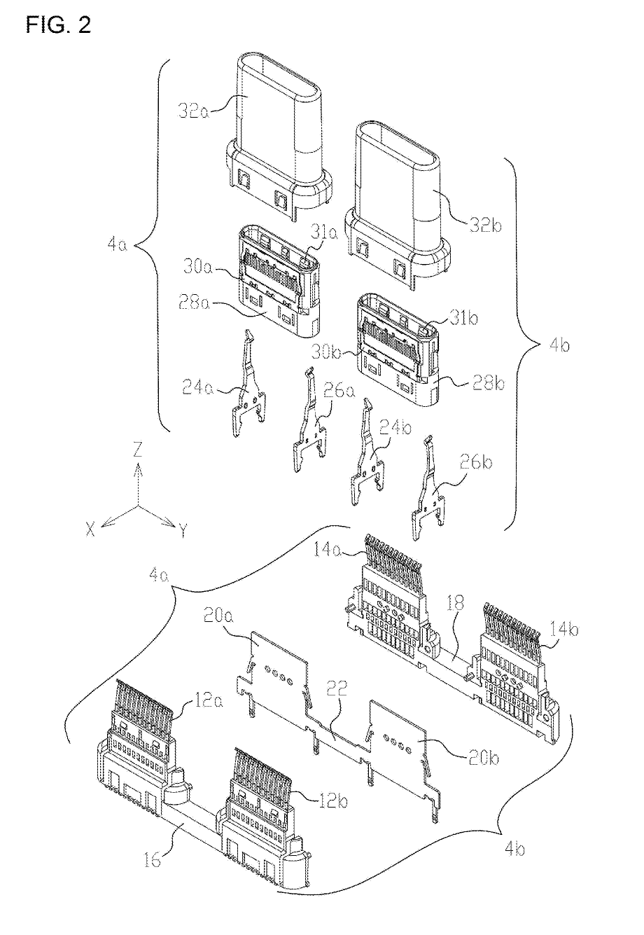

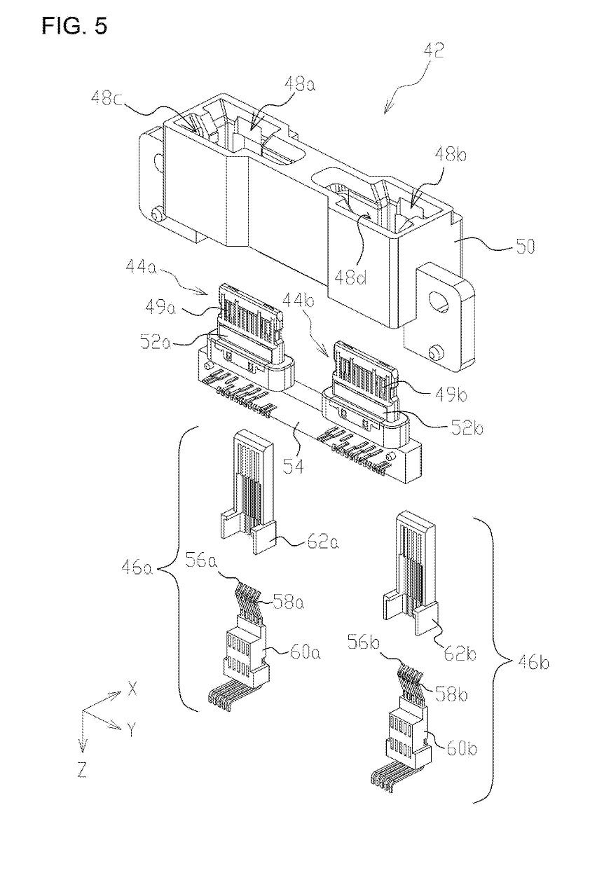

FIG. 2 is an exploded view showing a configuration of the two plug connectors 4a and 4b. As shown in FIG. 2, the plug connector 4a includes a plurality of contacts 12a and 14a to be connected with a contact not shown and a contact 49a (see FIG. 5) of a USB Type-C receptacle connector (hereinafter, referred to simply as a receptacle connector) 44a which will be described later. The plurality of contacts 12a is arranged on the +X direction side of the plug connector 4a, the plurality of contacts 14a is arranged on the −X direction side of the plug connector 4a. Similarly, the plug connector 4b includes a plurality of contacts 12b and 14b to be connected with a contact not shown and a contact 49b (see FIG. 5) of a receptacle connector 44b which will be described later. The plurality of contacts 12b is arranged on the +X direction side of the plug connector 4b and the plurality of contacts 14b is arranged on the −X direction side of the plug connector 4b.

The plurality of contacts 12a and 12b are held by an insert housing 16 formed of one insulator. Similarly, the plurality of contacts 14a and 14b are held by an insert housing 18 formed of one insulator. The insert housings 16 and 18 define an interval between the plug connectors 4a and 4b, and postures of the plug connectors 4a and 4b. Defining the interval between the plug connectors 4a and 4b, and thus an interval between the contacts 12a and 12b and an interval between the contacts 14a and 14b enables the contacts 12a and 12b to be securely connected with the contacts not shown of the receptacle connectors 44a and 44b, and the contacts 14a and 14b to be securely connected with the contacts 49a and 49b (see FIG. 5). Additionally, defining the postures of the plug connectors 4a and 4b, i.e. defining an inclination on an XY plane, and a position and an inclination in the Z axis direction enables the plug connectors 4a and 4b to be securely engaged with the receptacle connectors 44a and 44b without damages.

Additionally, the plug connector 4a has a ground plate 20a between the contacts 12a and 14a, and the plug connector 4b includes a ground plate 20b between the contacts 12b and 14b, with the ground plates 20a and 20b being coupled by a coupling portion 22. Additionally, the plug connector 4a includes two ground contacts 24a and 26a, and the plug connector 4b includes two ground contacts 24b and 26b. The ground contact 24a is arranged on the −Y direction side of the plug connector 4a, and the ground contact 26a is arranged on the +Y direction side of the plug connector 4a, with the ground contacts 24a and 26a being connected with the ground plate 20a. The ground contact 24b is arranged on the −Y direction side of the plug connector 4b, and the ground contact 26b is arranged on the +Y direction side of the plug connector 4b, with the ground contacts 24b and 26b being connected with the ground plate 20b.

Additionally, the plug connector 4a has a housing 28a in which housing 28a, the plurality of contacts 12a held by the insert housing 16, the plurality of contacts 14a held by the insert housing 18, the ground plate 20a, and the two ground contacts 24a and 26a are arranged. Additionally, the housing 28a holds the ground plate contacts 30a and 31a.

The ground plate contact 30a is arranged on the +X direction side of the housing 28a. The ground plate contact 30a is connected with a receptacle ground shell not shown of the receptacle connector 44a when the plug connector 4a engages with the receptacle connector 44a (see FIG. 4). The ground plate contact 31a is arranged on the −X direction side of the housing 28a. The ground plate contact 31a is connected with a receptacle ground shell 52a (see FIG. 5) when the plug connector 4a engages with the receptacle connector 44a.

Similarly, the plug connector 4b has a housing 28b, in which housing 28b, the plurality of contacts 12b held by the insert housing 16, the plurality of contacts 14b held by the insert housing 18, the ground plate 20b, and the two ground contacts 24b and 26b are arranged. Additionally, the housing 28b holds ground plate contacts 30b and 31b.

The ground plate contact 30b is arranged on the +X direction side of the housing 28b. When the plug connector 4b engages with the receptacle connector 44b (see FIG. 4), the ground plate contact 30b is connected with the receptacle ground shell not shown of the receptacle connector 44b. The ground plate contact 31b is arranged on the −X direction side of the housing 28b. When the plug connector 4b engages with the receptacle connector 44b, the ground plate contact 31b is connected with a receptacle ground shell 52b (see FIG. 5).

Additionally, the plug connector 4a has a shell 32a, which shell 32a covers an outer circumference of the housing 28a, a side on which the plurality of contacts 12a of the insert housing 16 is held (the −Y direction side), and a side on which the plurality of contacts 14a of the insert housing 18 is held (the −Y direction side). Similarly, the plug connector 4b has a shell 32b, which shell 32b covers an outer circumference of the housing 28b, a side on which the plurality of contacts 12b of the insert housing 16 is held (the +Y direction side), and a side on which the plurality of contacts 14b of the insert housing 18 is held (the +Y direction side).

FIG. 3 is a view showing configurations of the guide housing 10 and the additional plug connectors 6a to 6d. The guide housing 10, as shown in FIG. 3, includes the four guides 8a to 8d to hold the two plug connectors 4a and 4b. The four guides 8a to 8d are formed of a material having high strength, e.g. metal, and formed in the periphery of the two plug connectors 4a and 4b. Specifically, the guide 8a is formed on the +X direction side and the −Y direction side of the plug connector 4a, the guide 8b is formed on the +X direction side and the +Y direction side of the plug connector 4b, the guide 8c is formed on the −X direction side and the −Y direction side of the plug connector 4a, and the guide 8d is formed on the −X direction side and the +Y direction side of the plug connector 4b.

In the guide 8a, an opening 33a is formed in which the additional connector 6a fits, as an arrangement portion in which the additional connector 6a is arranged. Similarly, in the guides 8b to 8d, openings 33b to 33d are formed in which the additional connectors 6b to 6d fit, as arrangement portions in which the additional connectors 6b to 6d are arranged. The arrangement portions can be configured to be provided with, other than openings, concaves in which the additional connectors 6a to 6d fit.

Additionally, front end portions on the +Z direction side of the guides 8a to 8d protrude more in the +Z direction than front end portions on the +Z direction side of the plug connectors 4a and 4b. Specifically, the guides 8a to 8d protrude more than the plug connectors 4a and 4b to a side of an insertion direction (the +Z direction) in which the guides 8a to 8d are inserted into the guide insertion portions 48a to 48d (see FIG. 4). Accordingly, when the plug docking connector 2 docks with the receptacle docking connector 42, the guides 8a to 8d are inserted into the guide insertion portions 48a to 48d of the receptacle docking connector 42 before the plug connectors 4a and 4b start engaging with the receptacle connectors 44a and 44b.

As shown in FIG. 1, the additional plug connector 6a is arranged in the opening 33a of the guide 8a. As shown in FIG. 3, the additional plug connector 6a includes a plurality (five in the first embodiment) of contacts 34a, and a housing 36a which holds the plurality of contacts 34a. As shown in FIG. 3, the contacts 34a each have a connection surface 35a which connects with a connection terminal 58a (see FIG. 5) of a contact 56a of an additional receptacle connector 46a (see FIG. 4). As shown in FIG. 1, the connection surface 35a is arranged on a plane substantially flush with a guide surface 9a as a top surface of the guide 8a.

The additional plug connector 6b is arranged in the opening 33b of the guide 8b, and includes a plurality (five in the first embodiment) of contacts 34b, and a housing 36b which holds the plurality of contacts 34b. The contacts 34b each have a connection surface 35b which connects with a connection terminal 58b (see FIG. 5) of a contact 56b of an additional receptacle connector 46b (see FIG. 4). As shown in FIG. 1, the connection surface 35b is arranged on a plane substantially flush with a guide surface 9b as a top surface of the guide 8b.

The additional plug connector 6c is arranged in the opening 33c of the guide 8c and includes a plurality of contacts (not shown), and a housing 36c which holds the plurality of contacts. The additional plug connector 6d is arranged in an opening 33d of the guide 8d and includes a plurality of contacts (not shown), and a housing 36d which holds the plurality of contacts.

Next, description will be made of a docking connector on a receptacle side (hereinafter, referred to as a receptacle docking connector) as a receptacle unit according to the first embodiment of the present invention with reference to the drawings. FIG. 4 is a perspective view showing an appearance of the receptacle docking connector according to the first embodiment. The receptacle docking connector 42 is mounted on a portable terminal device such as a tablet type PC or the like, and as shown in FIG. 4, includes a guide shell 50 having the two receptacle connectors 44a and 44b, the two additional receptacle connectors 46a and 46b, and the four guide insertion portions 48a to 48d.

FIG. 5 is an exploded view for explaining a configuration of the receptacle docking connector 42. As shown in FIG. 5, the receptacle connector 44a includes a plurality of contacts (not shown) which connects with the contacts 12a of the plug connector 4a, and the plurality of contacts 49a which connects with the contact 14a. The plurality of contacts not shown is arranged on the +X direction side of the receptacle connector 44a, and the plurality of the contact 49a is arranged on the −X direction side of the receptacle connector 44a. Similarly, the receptacle connector 44b includes a plurality of contacts (not shown) which connects with the contacts 12b of the plug connector 4b, and the plurality of the contacts 49b which connects with the contact 14b. The plurality of contacts not shown is arranged on the +X direction side of the receptacle connector 44b, and the plurality of contacts 49b is arranged on the −X direction side of the receptacle connector 44b.

Additionally, the receptacle connector 44a includes the receptacle ground shell 52a, and a receptacle ground shell not shown. The receptacle ground shell 52a is arranged on the −X direction side of the receptacle connector 44a, and the receptacle ground shell not shown is arranged on the +X direction side of the receptacle connector 44a. When the receptacle connector 44a engages with the plug connector 4a, the receptacle ground shell 52a connects with the ground plate contact 31a. When the receptacle connector 44a engages with the plug connector 4a, the receptacle ground shell not shown connects with the ground plate contact 30a.

The receptacle connector 44b includes the receptacle ground shell 52b and a receptacle ground shell not shown. The receptacle ground shell 52b is arranged on the −X direction side of the receptacle connector 44b, and the receptacle ground shell not shown is arranged on the +X direction side of the receptacle connector 44a. When the receptacle connector 44b engages with the plug connector 4b, the receptacle ground shell 52b connects with the ground plate contact 31b. When the receptacle connector 44b engages with the plug connector 4b, the receptacle ground shell not shown connects with the ground plate contact 30b.

The plurality of contacts 49a and 49b, a plurality of contacts not shown of the receptacle connectors 44a and 44b, the receptacle ground shells 52a and 52b, and receptacle ground shells not shown of the receptacle connectors 44a and 44b are held by a receptacle housing 54 formed of one insulator. The receptacle housing 54 defines an interval between the receptacle connectors 44a and 44b, and postures of the receptacle connectors 44a and 44b. Defining the interval between the receptacle connectors 44a and 44b, and thus an interval between the contacts 49a and 49b enables the contacts 49a and 49b to be securely connected with the contacts 14a and 14b of the plug connectors 4a and 4b. Similarly, defining an interval between contacts not shown of the receptacle connector 44a and contacts not shown of the receptacle connector 44b enables the contacts not shown of the receptacle connector 44a and the contacts not shown of the receptacle connector 44b to be securely connected with the contacts 12a and 12b of the plug connectors 4a and 4b. Additionally, defining the postures of the receptacle connectors 44a and 44b, i.e. defining an inclination on the XY plane, and a position and an inclination in the Z axis direction enables the receptacle connectors 44a and 44b to be securely engaged with the plug connectors 4a and 4b without damages.

The guide shell 50 covers an outer circumference of the receptacle housing 54 (the receptacle connectors 44a and 44b) and holds the two receptacle connectors 44a and 44b by holding the receptacle housing 54. The guide shell 50 includes the four guide insertion portions 48a to 48d, which are formed in the periphery of the receptacle connectors 44a and 44b. Specifically, the guide insertion portion 48a is formed on the +X direction side and on the −Y direction side of the receptacle connector 44a, the guide insertion portion 48b is formed on the +X direction side and on the +Y direction side of the receptacle connector 44b, the guide insertion portion 48c is formed on the −X direction side and the −Y direction side of the receptacle connector 44a, and the guide insertion portion 48d is formed on the −X direction side and on the +Y direction side of the receptacle connector 44b.

Additionally, insertion ports of the guide insertion portions 48a to 48d protrude more in the −Z direction side than front end portions of the receptacle connectors 44a and 44b on the −Z direction side. Accordingly, when the receptacle docking connector 42 docks with the plug docking connector 2, the guide insertion portions 48a to 48d receive the guides 8a to 8d of the plug docking connector 2 before the receptacle connectors 44a and 44b start engaging with the plug connectors 4a and 4b.

As shown in FIG. 4, the additional receptacle connector 46a is arranged on the +X direction side of the guide insertion portion 48a. As shown in FIG. 5, the additional receptacle connector 46a includes the plurality (five in the first embodiment) of contacts 56a. The contact 56a has the connection terminal 58a which connects with the contact 34a of the additional plug connector 6a, the connection terminal 58a being formed of an elastic body. Additionally, the additional receptacle connector 46a includes an additional receptacle housing 60a which holds the plurality of contacts 56a, and a receptacle guide housing 62a which holds the additional receptacle housing 60a.

As shown in FIG. 4, the additional receptacle connector 46b is arranged on the +X direction side of the guide insertion portion 48b. As shown in FIG. 5, the additional receptacle connector 46b includes the plurality (five in the first embodiment) of contacts 56b. The contact 56b has the connection terminal 58b which connects with the contact 34b of the additional plug connector 6b, the connection terminal 58b being formed of an elastic body. Additionally, the additional receptacle connector 46b includes an additional receptacle housing 60b which holds the plurality of contacts 56b, and a receptacle guide housing 62b which holds the additional receptacle housing 60b.

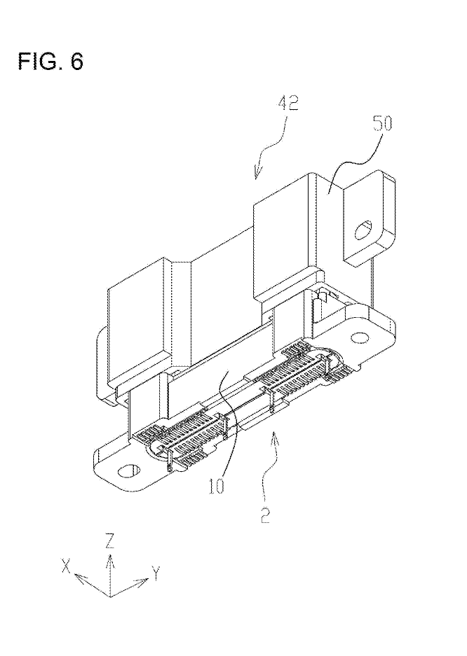

In the above-described first embodiment, as shown in FIG. 6, the description has been made of a case where the receptacle connector 44a is engaged with the plug connector 4a, and the receptacle connector 44b is engaged with the plug connector 4b. In this case, the additional receptacle connector 46a is connected with the additional plug connector 6a, and the additional receptacle connector 46b is connected with the additional plug connector 6b. However, the plug docking connector 2 and the receptacle docking connector 42 according to the first embodiment are reversible connectors, and the receptacle connector 44a can be engaged with the plug connector 4b, and the receptacle connector 44b can be engaged with the plug connector 4a as well. In this case, the additional receptacle connector 46a is connected with the additional plug connector 6d, and the additional receptacle connector 46b is connected with the additional plug connector 6c.

A plurality of contacts not shown of the additional plug connector 6c each have a connection surface which connects with the connection terminal 58b of the contact 56b of the additional receptacle connector 46b. The connection surface is arranged on a plane substantially flush with a guide surface (not shown) as a top surface of the guide 8c. Similarly, a plurality of contacts not shown of the additional plug connector 6d each have a connection surface which connects with the connection terminal 58a of the contact 56a of the additional receptacle connector 46a. The connection surface is arranged on a plane substantially flush with a guide surface (not shown) as a top surface of the guide 8d.

With the plug docking connector 2 according to the first embodiment, since the plurality of contacts 12a and 12b is held by the insert housing 16 formed of one insulator, and the plurality of contacts 14a and 14b is held by the insert housing 18 formed of one insulator, an interval between the plug connectors 4a and 4b and postures of the plug connectors 4a and 4b are defined. Accordingly, a tolerance can be minimized to enable the contacts 12a and 12b to be securely connected with the contacts not shown of the receptacle connectors 44a and 44b, and the contacts 14a and 14b to be securely connected with the contacts 49a and 49b. Additionally, the plug connectors 4a and 4b can be securely engaged with the receptacle connectors 44a and 44b without damages.

Additionally, with the receptacle docking connector 42 according to the first embodiment, since the contacts 49a and 49b and the like are held by the receptacle housing 54 formed of one insulator, an interval between the receptacle connectors 44a and 44b and postures of the receptacle connectors 44a and 44b are defined. Accordingly, a tolerance can be minimized to enable the contacts not shown of the receptacle connectors 44a and 44b to be securely connected with the contacts 12a and 12b, and the contacts 49a and 49b to be securely connected with the contacts 14a and 14b. Additionally, the receptacle connectors 44a and 44b can be securely engaged with the plug connectors 4a and 4b without damages.

Additionally, although when a connector is further added to a docking connector having predetermined standard connectors such as a plurality of connectors conforming to the standard specification, there occurs a problem of an increase in the docking connector, with the plug docking connector 2 according to the first embodiment, since the additional plug connectors 6a to 6d are arranged in the guides 8a to 8d, the plug docking connector 2 can be reduced in size. Similarly, with the receptacle docking connector 42 according to the first embodiment, since the additional receptacle connectors 46a and 46b are arranged in the guide insertion portions 48a and 48b, the receptacle docking.

Although the above plug docking connector 2 according to the first embodiment has been described with respect to a case where the guide surfaces 9a and 9b of the guides 8a and 8b are plane surfaces, the present invention is applicable also to a case where the guide surfaces are curved surfaces. Even when the guide surfaces are curved surfaces, the connection surfaces 35a and 35b can be arranged on a plane substantially flush with the guide surfaces. Similarly, guide surfaces not shown of the guides 8c and 8d are also plane surfaces or curved surfaces, and connection surfaces not shown of the additional connectors 6c and 6d are arranged on a plane substantially flush with the guide surfaces not shown of the guides 8c and 8d.

Additionally, although the above plug docking connector 2 according to the first embodiment is provided with the four additional plug connectors 6a to 6d, only at least two additional plug connectors need to be provided. Additionally, although the above receptacle docking connector 42 according to the embodiment is provided with the two additional receptacle connectors 46a and 46b, only at least one additional receptacle connector need to be provided.

Additionally, in the above plug docking connector 2 according to the first embodiment, the front end portions of the guides 8a to 8d in the +Z direction protrude more than the front end portions of the plug connectors 4a and 4b, and the insertion ports of the guide insertion portions 48a to 48d of the receptacle docking connector 42 protrude more than the front end portions of the receptacle connectors 44a and 44b. However, only at least either one of the front end portions of the guides 8a to 8d and the insertion ports of the guide insertion portions 48a to 48d need to protrude. Specifically, the configuration need only allow the guides 8a to 8d to be inserted into the guide insertion portions 48a to 48d before the plug connectors 4a and 4b start engaging with the receptacle connectors 44a and 44b.

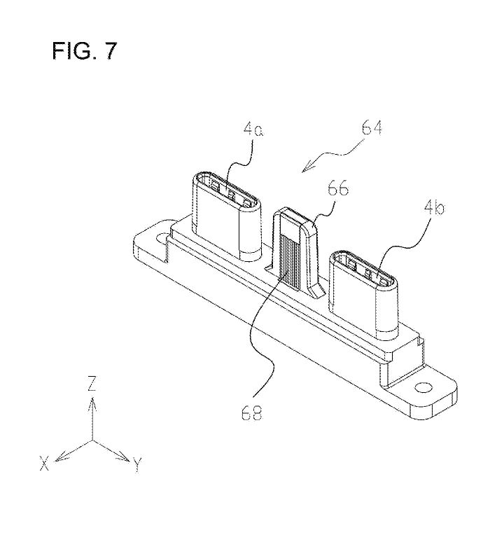

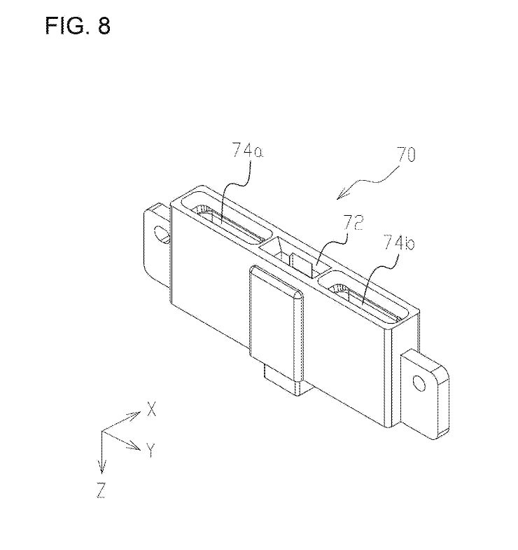

Additionally, although in the above plug docking connector 2 according to the first embodiment, the guides 8a to 8d are formed around the plug connectors 4a and 4b, a guide 66 can be formed between the plug connectors 4a and 4b, for example, such a plug docking connector 64 as shown in FIG. 7. In this case, as shown in FIG. 7, at least one additional plug connector 68 is arranged in the guide 66. FIG. 8 is a view showing an appearance of a receptacle docking connector 70 which docks with the plug docking connector 64 shown in FIG. 7. While in the above receptacle docking connector 42 according to the embodiment, the guide insertion portions 48a to 48d are formed around the receptacle connectors 44a and 44b, in the receptacle docking connector 70, as shown in FIG. 8, a guide insertion portion 72 is formed between housing portions 74a and 74b which house the receptacle connectors 44a and 44b (see FIG. 4). In this case, at least one additional receptacle connector (not shown) which connects with the plug connector 68 is arranged in the guide insertion portion 72.

The guide 66 shown in FIG. 7 is formed of a material having high strength, e.g. metal, and a front end portion of the guide 66 protrudes in the +Z direction more than the front end portions of the plug connectors 4a and 4b. Accordingly, when the plug docking connector 64 docks with the receptacle docking connector 70, the guide 66 is inserted into the guide insertion portion 72 of the receptacle docking connector 70 before the plug connectors 4a and 4b start engaging with the receptacle connectors 44a and 44b. Since in the plug docking connector 64 and the receptacle docking connector 70, one guide 66 and guide insertion portion 72 are provided, respectively, and the additional plug connector 68 is arranged in the guide 66 and the additional receptacle connector is arranged in the guide insertion portion 72, the plug docking connector 64 and the receptacle docking connector 70 can be reduced in size.

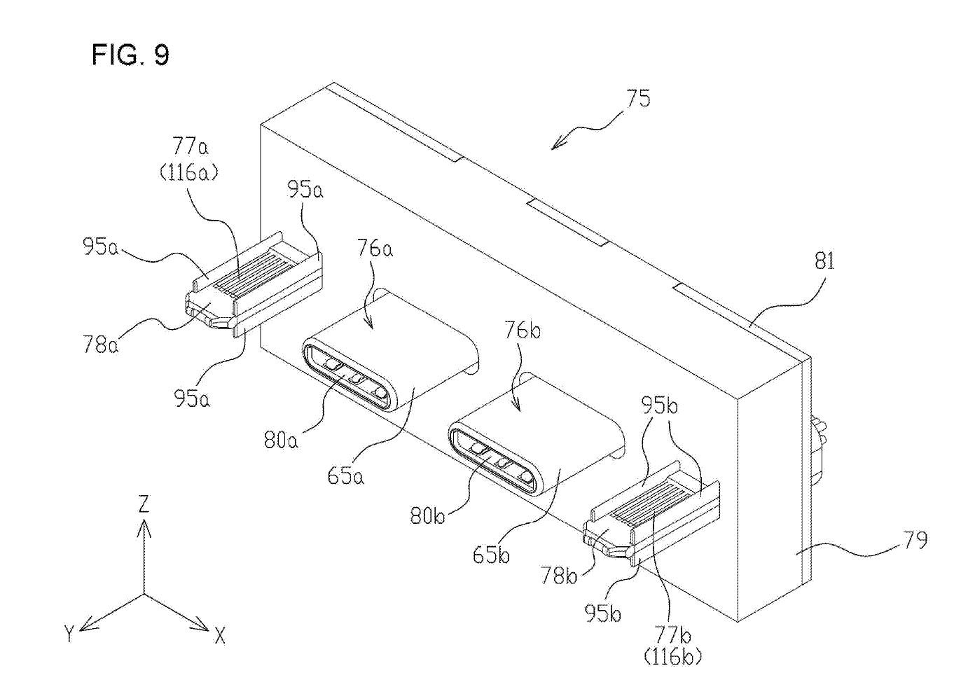

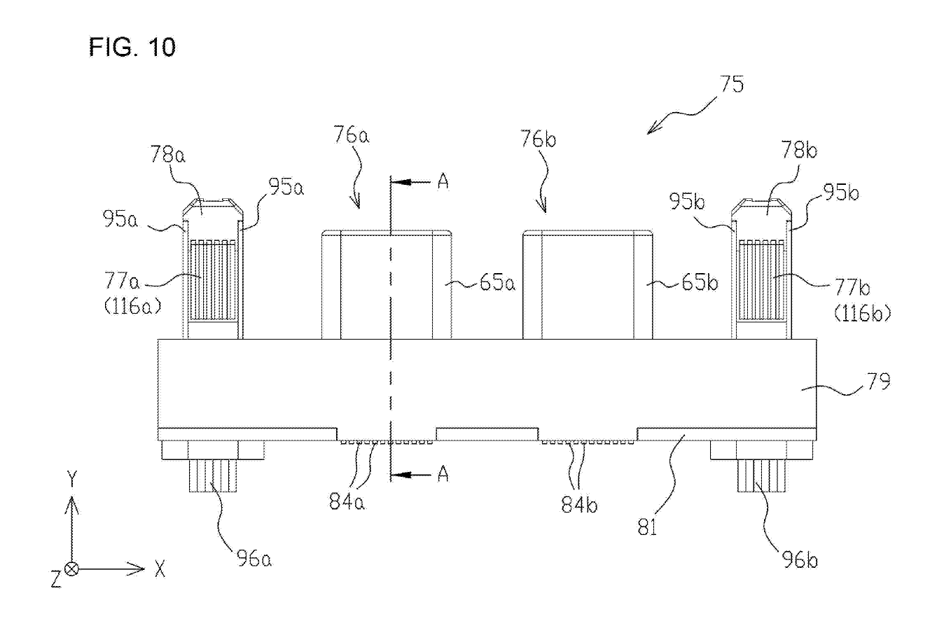

Next, a docking connector according to a second embodiment of the present invention will be described with reference to the drawings. FIG. 9 is a perspective view showing an appearance of a plug docking connector as a plug unit according to the second embodiment, FIG. 10 is a bottom plan view showing the appearance of the plug docking connector according to the second embodiment. As shown in FIG. 9 and FIG. 10, a plug docking connector 75 includes a front cover 79 having two USB Type-C plug connectors (hereinafter, referred to simply as a plug connector) 76a and 76b, two additional plug connectors 77a and 77b, and two guide portions 78a and 78b, and a rear cover 81. The docking connector is a connector for connecting a portable terminal device with an external apparatus, which represents, in a broad sense, such a docking connector as incorporated into an apparatus main body, as housed in a housing or the like and as connected with an apparatus via a cable or the like, or other.

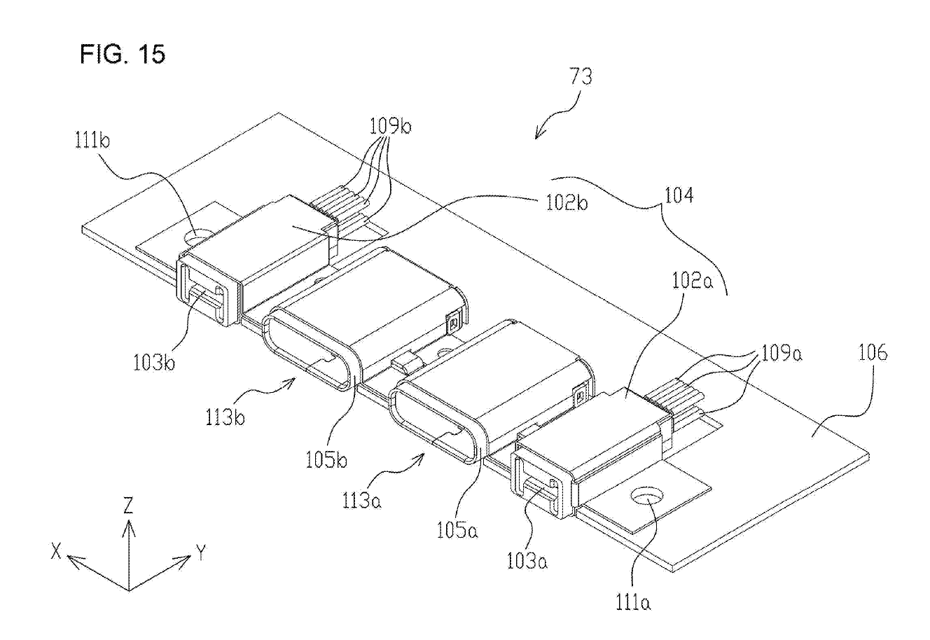

Additionally, in the following, with an XYZ orthogonal coordinate system set as shown in FIG.9, description will be made of a positional relationship and the like of each member with reference to the orthogonal coordinate system. An X axis is set to be parallel to a direction in which the two plug connectors 76a and 76b are arranged. A Y axis is set to be parallel to a direction in which the plug docking connector 75 is docked with a receptacle docking connector 73 (see FIG. 15). A Z axis is set to be in a direction orthogonal to an YZ plane. Additionally, a side of the plug connector 76b is set to be a +X direction and a side of the plug connector 76a is set to be a −X direction, and a direction in which the plug docking connector 75 is docked with the receptacle docking connector is set to be a +Y direction and a direction in which the plug docking connector 75 is pulled out from the receptacle docking connector is set to be a −Y direction.

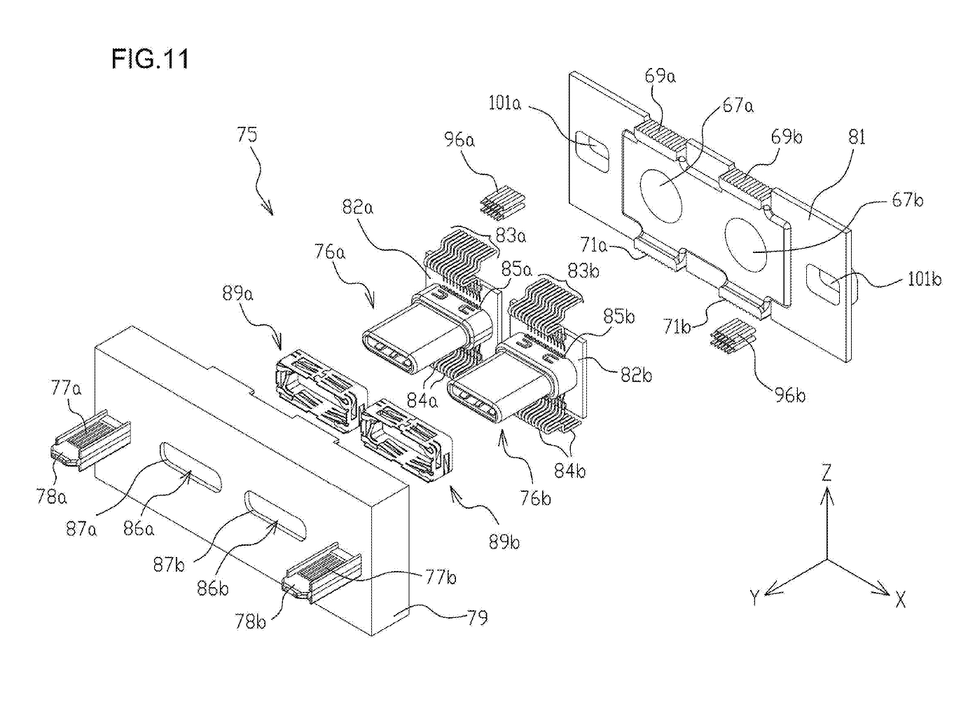

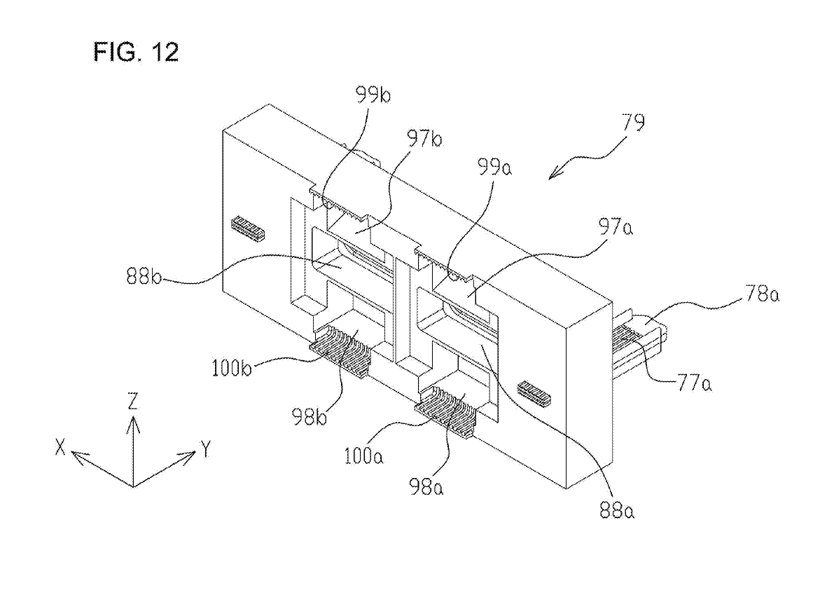

FIG. 11 is an exploded view showing a configuration of the plug docking connector 75, and FIG. 12 is a perspective view showing an appearance of the front cover 79 seen from the −Y direction. As shown in FIG. 9 to FIG. 12, the front cover 79 functions as a cover which covers the plug connectors 76a and 76b.

When docking with the receptacle docking connector 73 including two USB Type-C receptacle connectors (hereinafter, referred to simply as receptacle connectors) 113a and 113b (see FIG. 15), the front cover 79 includes the two guide portions 78a and 78b to be inserted into guide reception portions 102a and 102b (see FIG. 15) of the receptacle docking connector 73 before the plug connectors 76a and 76b fit in the two receptacle connectors 113a and 113b (see FIG. 15). The two guide portions 78a and 78b are formed integrally with the front cover 79, and the front cover 79 and the two guide portions 78a and 78b are formed of resin. The guide portion 78a is formed on the −X direction side of the plug connector 76a, and the guide portion 78b is formed on the +X direction side of the plug connector 76b.

The guide portion 78a has a member 95a with a high strength (metal in this embodiment) insert-molded therein. Similarly, the guide portion 78b has a member 95b with a high strength (metal in this embodiment) insert-molded therein. Insert-molding of the metals 95a and 95b in the guide portions 78a and 78b enables an increase in the guide portions 78a and 78b in strength, and enables breakage of the guide portions 78a and 78b to be prevented when the guide portions 78a and 78b are inserted into the guide reception portions 102a and 102b of the receptacle docking connector 73. The metals 95a and 95b can be incorporated into the guide portions 78a and 78b by fitting-in, embedding and the like other than by insert-molding.

Additionally, front end portions on the +Y direction side of the guide portions 78a and 78b protrude more in the +Y direction than front end portions on the +Y direction side of the plug connectors 76a and 76b. Specifically, the guide portions 78a and 78b protrude more than the plug connectors 76a and 76b to a side of an insertion direction (the +Y direction)in which the guide portions 78a and 78b are inserted into the guide reception portions 102a and 102b of the receptacle docking connector 73. Accordingly, when the plug docking connector 75 docks with the receptacle docking connector 73, the guide portions 78a and 78b are inserted into the guide reception portions 102a and 102b of the receptacle docking connector 73 before the plug connectors 76a and 76b fit in the receptacle connectors 113a and 113b.

Additionally, a width W (mm) of each of the guide portions 78a and 78b in a direction (Z direction) orthogonal to a direction in which the plug connectors 76a and 76b are aligned is equal to or more than an internal diameter width D (mm) in the Z direction of an internal diameter of each of the receptacle connectors 113a and 113b. The width W (mm) of each of the guide portions 78a and 78b preferably satisfies D□W□(D+0.6) and more preferably satisfies D□W□(D+1). Accordingly, when the plug docking connector 75 docks with the receptacle docking connector 73, erroneous insertion of the guide portions 78a and 78b into the receptacle connectors 113a and 113b can be prevented.

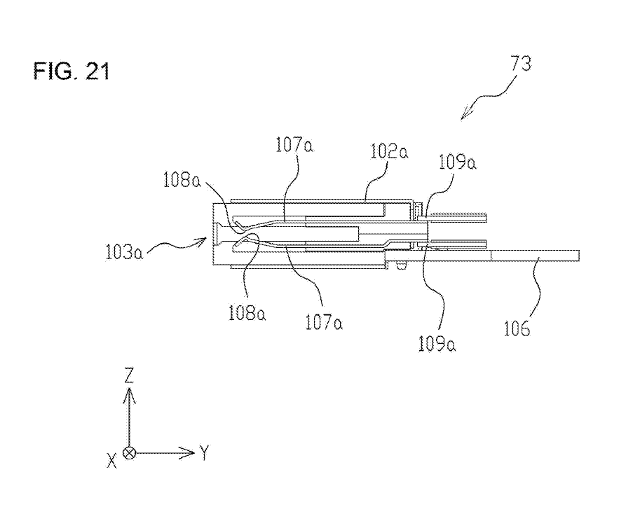

Additionally, the guide portion 78a has the additional plug connector 77a arranged therein, i.e., incorporated, and the additional plug connector 77a includes a plurality of contacts 116a as shown in FIG. 10. The contacts 116a each have a connection surface which connects with a connection terminal 108a of a contact 107a of an additional receptacle connector 103a (see FIG. 21). The connection surface is arranged on a plane substantially flush with a surface on the +Z side of the guide portion 78a. Additionally, the additional plug connector 77a also includes a plurality of contacts (not shown) on a surface on the −Z side of the guide portion 78a. The contacts not shown each have a connection surface which connects with the connection terminal 108a of the contact 107a of the additional receptacle connector 103a (see FIG. 21). The connection surface is arranged on a plane substantially flush with a surface on the −Z side of the guide portion 78a. The contacts 116a and contacts not shown of the additional plug connector 77a are electrically connected with cables 96a shown in FIG. 11.

Additionally, the guide portion 78b has the additional plug connector 77b arranged therein, i.e., incorporated, and the additional plug connector 77b includes a plurality of contacts 116b as shown in FIG. 10. The contacts 116b each have a connection surface which connects with a connection terminal (not shown) of a contact of an additional receptacle connector 103b (see FIG. 15). The connection surface is arranged on a plane substantially flush with a surface on the +Z side of the guide portion 78b. Additionally, the additional plug connector 77b also includes a plurality of contacts (not shown) on a surface on the −Z side of the guide portion 78b. The contacts not shown each have a connection surface which connects with a connection terminal (not shown) of a contact 107b of the additional receptacle connector 103b. The connection surface is arranged on a plane substantially flush with a surface on the −Z side of the guide portion 78b. The contacts 116b and contacts not shown of the additional plug connector 77b are electrically connected with cables 96b shown in FIG. 11.

Additionally, on the −X direction side between the guide portion 78a and the guide portion 78b of the front cover 79, an opening portion 86a is formed which covers the plug connector 76a and is for exposing a fit-in portion 80a at which the plug connector 76a fits in the receptacle connector 113a (see FIG. 15). Additionally, on the +X direction side between the guide portion 78a and the guide portion 78b of the front cover 79, an opening portion 86b is formed which covers the plug connector 76b and is for exposing a fit-in portion 80b at which the plug connector 76b fits in the receptacle connector 113b (see FIG. 15).

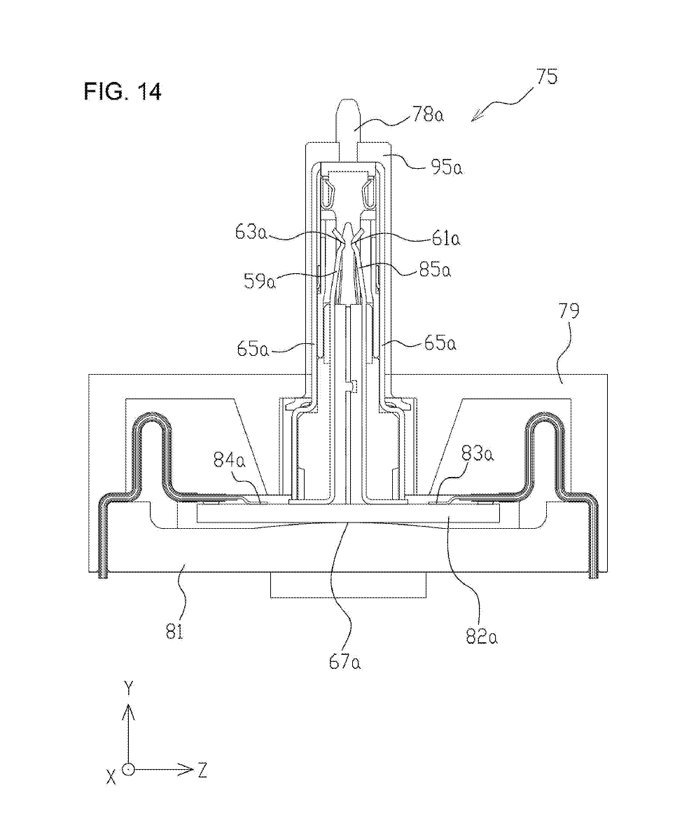

Additionally, in the front cover 79 (the rear of a surface on which the guide portions 78a and 78b are formed), as shown in FIG. 12, cable housing portions 97a and 98a are formed on the −X direction side, and cable housing portions 97b and 98b are formed on the +X direction side. The cable housing portion 97a is located on the +Z direction side to house a cable 83a (see FIG. 14). The cable housing portion 98a is located on the −Z direction side to house a cable 84a (see FIG. 14). The cable housing portion 97b is located on the +Z direction side to house a cable 83b (see FIG. 11). The cable housing portion 98b is located on the −Z direction side to house a cable 84b (see FIG. 11).

Further, in the front cover 79 (the rear of a surface on which the guide portions 78a and 78b are formed), as shown in FIG. 12, cable holding portions 99a and 100a are formed on the −X direction side, and cable holding portions 99b and 100b are formed on the +X direction side. The cable holding portion 99a is located on the +Z direction side and holds the cable 83a (see FIG. 11), together with a cable holding portion 69a of the rear cover 81 (see FIG. 11). The cable holding portion 100a is located on the −Z direction side and holds the cable 84a (see FIG. 11), together with a cable holding portion 71a of the rear cover 81 (see FIG. 11). The cable holding portion 99b is located on the +Z direction side and holds the cable 83b (see FIG. 11), together with a cable holding portion 69b of the rear cover 81 (see FIG. 11). The cable holding portion 100b is located on the −Z direction side and holds the cable 84b (see FIG. 11), together with a cable holding portion 71b of the rear cover 81 (see FIG. 11). The cable holding portions 99a, 99b, 100a, and 100b function as second holding portions which hold the cables 83a, 83b, 84a, and 84b, respectively, together with the cable holding portions 69a, 69b, 71a, and 71b of the rear cover 81 which will be described later. The second holding portion will be detailed later.

Additionally, between an outer wall portion of the plug connector 76a, i.e., a plug shell 65a which will be described later, and a wall portion 87a formed on the +Y direction side of the opening portion 86a, a predetermined space is formed such that on a surface on which the opening portion 86a is formed (ZX plane), the plug connector 76a can move relative to the front cover 79 (the rear cover 81 fixed to the front cover 79) as shown in FIG. 9. Similarly, between an outer wall portion of the plug connector 76b, i.e. a plug shell 65b which will be described later, and a wall portion 87b formed on the +Y direction side of the opening portion 86b, a predetermined space is formed such that on a surface on which the opening portion 86b is formed (ZX plane), the plug connector 76b can move relative to the front cover 79 (the rear cover 81 fixed to the front cover 79).

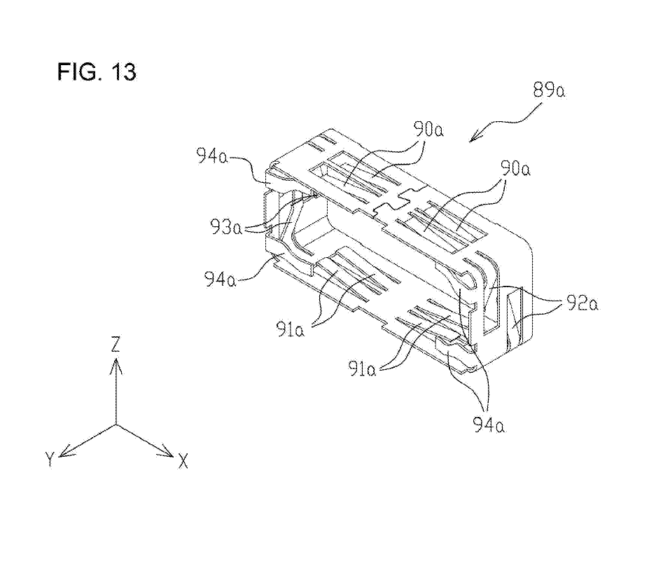

Between the outer wall portion of the plug connector 76a and the front cover 79 (a wall portion 88a formed on the −Y direction side of the opening portion 86a), a control portion 89a is provided. FIG. 13 is a view showing a configuration of the control portion 89a. The control portion 89a is formed of a conductive member, e.g., metal, and on the +Z direction side of the control portion 89a, as shown in FIG. 13, four Z side elastic portions 90a are formed. Additionally, on the −Z direction side of the control portion 89a, four Z side elastic portions 91a are formed. The control portion 89a is incorporated into the opening portion 86a, and the Z side elastic portion 90a pushes the outer wall portion on the +Z direction side of the plug connector 76a toward the −Z direction by an elastic force. The outer wall portion on the +Z direction side of the plug connector 76a receives the elastic force of the Z side elastic portion 90a. The Z side elastic portion 91a pushes the outer wall portion on the −Z direction side of the plug connector 76a toward the +Z direction by an elastic force. The outer wall portion on the −Z side of the plug connector 76a receives an elastic force of the Z side elastic portion 91a.

The control portion 89a controls a position of the plug connector 76a in the Z direction relative to the opening portion 86a by using elastic forces of the Z side elastic portions 90a and 91a. For example, when a force in the −Z direction is applied to the plug connector 76a, the Z side elastic portion 90a extends in the −Z direction and the Z side elastic portion 91a contracts in the −Z direction. Accordingly, the plug connector 76a moves in the −Z direction within a predetermined space formed between the outer wall portion of the plug connector 76a and the wall portion 88a. When a force in the +Z direction is applied to the plug connector 76a, the Z side elastic portion 90a contracts in the +Z direction, and the Z side elastic portion 91a extends in the +Z direction. Accordingly, the plug connector 76a moves in the +Z direction within the predetermined space formed between the outer wall portion of the plug connector 76a and the wall portion 88a.

Additionally, on the +X direction side of the control portion 89a, as shown in FIG. 13, two X side elastic portions 92a are formed. Additionally, on the −X direction side of the control portion 89a, two X side elastic portions 93a are formed. The X side elastic portion 92a pushes the outer wall portion on the +X direction side of the plug connector 76a toward the −X direction by an elastic force. The outer wall portion on the +X direction side of the plug connector 76a receives the elastic force of the X side elastic portion 92a. The X side elastic portion 93a pushes the outer wall portion on the −X direction side of the plug connector 76a toward the +X direction by an elastic force. The outer wall portion on the −X direction side of the plug connector 76a receives the elastic force of the X side elastic portion 93a.

The control portion 89a controls a position of the plug connector 76a in the X direction relative to the opening portion 86a by using elastic forces of the X side elastic portions 92a and 93a. For example, when a force in the −X direction is applied to the plug connector 76a, the X side elastic portion 92a extends in the −X direction, and the X side elastic portion 93a contracts in the −X direction. Accordingly, the plug connector 76a moves in the −X direction within the predetermined space formed between the outer wall portion of the plug connector 76a and the wall portion 88a. When a force in the +X direction is applied to the plug connector 76a, the X side elastic portion 92a contracts in the +X direction, and the X side elastic portion 93a extends in the +X direction. Accordingly, the plug connector 76a moves in the +X direction within the predetermined space formed between the outer wall portion of the plug connector 76a and the wall portion 88a.

Additionally, on the +Y direction side of the control portion 89a, as shown in FIG. 13, four Y side elastic portions 94a are formed. The control portion 89a controls a posture of the plug connector 76a relative to the opening portion 86a by using the Y side elastic portion 94a and a convex portion 67a formed in the rear cover 81 (see FIG. 11). Posture control of the control portion 89a will be detailed later.

Additionally, between the outer wall portion of the plug connector 76b and the front cover 79 (a wall portion 88b formed on the −Y direction side of the opening portion 86b), a control portion 89b is provided. The control portion 89b is formed of a conductive member, e.g., metal, and is incorporated in the opening portion 86b. On the +Z direction side of the control portion 89b, four Z side elastic portions are formed which have the same function and effect as those of the Z side elastic portion 90a of the control portion 89a. Additionally, on the −Z direction side of the control portion 89b, four Z side elastic portions are formed which have the same function and effect as those of the Z side elastic portion 91a of the control portion 89a.

Additionally, on the +X direction side of the control portion 89b, two X side elastic portions are formed which have the same function and effect as those of the X side elastic portion 92a of the control portion 89a. Additionally, on the −X direction side of the control portion 89b, two X side elastic portions are formed which have the same function and effect as those of the X side elastic portion 93a of the control portion 89a. Additionally, on the +Y direction side of the control portion 89b, four Y side elastic portions are formed which have the same function and effect as those of the Y side elastic portion 94a of the control portion 89a. Since position control and posture control of the plug connector 76b of the control portion 89b are the same as the position control and the posture control of the plug connector 76a in the control portion 89a, no description will be made thereof.

Next, a configuration of the plug connector 76a will be described. FIG. 14 is a sectional view taken along A-A in FIG. 10. The plug connector 76a is mounted on a circuit board 82a as shown in FIG. 11 and FIG. 14. As shown in FIG. 14, the plug connector 76a includes a plurality of contacts 85a and a plurality of contacts 59a which connect with a plurality of contacts (not shown) of the receptacle connectors 113a and 113b (see FIG. 15), and the plug shell 65a covering the plurality of contacts 85a and 59a. Each of the plurality of contacts 85a is arranged on the +Z direction side of the plug connector 76a, and an end portion on the −Y direction side of the contact 85a is fixed to the circuit board 82a by soldering or the like. Additionally, each of the plurality of contacts 85a includes a contact portion 61a at an end portion thereof on the +Y direction side, the contact portion 61a for coming into contact with the contacts (not shown) of the receptacle connectors 113a and 113b (see FIG. 15). Each of the plurality of contacts 59a is arranged on the −Z direction side of the plug connector 76a, and an end portion on the −Y direction side of the contact 59a is fixed to the circuit board 82a by soldering or the like. Additionally, each of the plurality of contacts 59a includes a contact portion 63a at an end portion thereof on the +Y direction side, the contact portion 63a for coming into contact with the contacts (not shown) of the receptacle connectors 113a and 113b.

Additionally, on the +Z direction side of the circuit board 82a, one end of each of the plurality of cables 83a is fixed by soldering or the like. Each of the plurality of cables 83a is electrically connected with each of the plurality of contacts 85a arranged on the +Z direction side of the plug connector 76a via the circuit board 82a. Additionally, to the −Z direction side of the circuit board 82a, one end of each of the plurality of cables 84a is fixed by soldering or the like. Each of the plurality of cables 84a is electrically connected with each of the plurality of contacts 59a arranged on the −Z direction side of the plug connector 76a via the circuit board 82a.

Next, a configuration of the plug connector 76b will be described. The plug connector 76b is mounted on a circuit board 82b as shown in FIG. 11. Additionally, the plug connector 76b includes a plurality of contacts not shown and the plug shell 65b (see FIG. 9). Configurations of these contacts and the shell are line-symmetrically the same as those of the plurality of contacts 85a and 59a and the plug shell 65a, i.e., with respect to a center line in the Y axis direction of the plug docking connector 75. Additionally, on the +Z direction side of the circuit board 82b, one end of each of the plurality of cables 83b is fixed by soldering or the like. Each of the plurality of cables 83b is electrically connected with each of a plurality of contacts 85b arranged on the +Z direction side of the plug connector 76b. Additionally, on the −Z direction side of the circuit board 82b, one end of the plurality of cables 84b is fixed by soldering or the like. Each of the plurality of cables 84b is electrically connected with each of a plurality of contacts (not shown) arranged on the −Z direction side of the plug connector 76b.

Here, the circuit boards 82a and 82b on which the plug connectors 76a and 76b are mounted function as first holding portions which hold one ends of the plurality of cables 83a and 83b, respectively, because one ends of the plurality of cables 83a and 83b are fixed to the circuit boards 82a and 82b, respectively. The first holding portion will be detailed later.

Next, a configuration of the rear cover 81 will be described. As shown in FIG. 9, the rear cover 81 is attached and fixed to the front cover 79 to support the plug connectors 76a and 76b from the −Y direction side. As shown in FIG. 11, on the −X direction side of the rear cover 81, an opening portion 101a is formed for leading the cable 96a from a space formed between the front cover 79 and the rear cover 81 to the outside. The cable 96a is fixed in the opening portion 101a by an adhesive not shown or the like. Additionally, on the +X direction side of the rear cover 81, an opening portion 101b is formed for leading the cable 96b from the space formed between the front cover 79 and the rear cover 81 to the outside. The cable 96b is fixed in the opening portion 101b by an adhesive not shown or the like.

Additionally, on a surface on the +Y direction side of the rear cover 81, the convex portion 67a as a part of the configuration of the control portion 89a, and a convex portion 67b as a part of the configuration of the control portion 89b are formed. The two convex portions 67a and 67b each have a convex surface on the +Y direction side, and the convex portion 67a is arranged on the +X direction side of the rear cover 81 to support the plug connector 76a in the +Y direction. The convex portion 67b is arranged on the −X direction side of the rear cover 81 to support the plug connector 76b in the +Y direction.

Using the Y side elastic portion 94a (see FIG. 13) and the convex portion 67a (see FIG. 11), the control portion 89a controls a posture of the plug connector 76a relative to the opening portion 86a, i.e. an inclination relative to the Y axis direction. For example, applying, to the plug connector 76a, a force in a direction slanting relative to the Y axis direction changes a direction in which the convex portion 67a supports the plug connector 76a and an elastic force of the Y side elastic portion 94a. Then, the posture of the plug connector 76a changes to a direction in which a force is applied in a predetermined space formed between the plug shell 65a and the wall portion 87a. Specifically, the plug connector 76a slants relative to a surface on which the opening portion 86a is formed. The Y side elastic portion 94a arranged on the side to which the plug connector 76a slants functions as a correction portion which uses an elastic force thereof to push the plug connector 76a, thereby correcting an inclination of the plug connector 76a. When the force applied to the plug connector 76a is released, by the elastic force of the Y side elastic portion 94a, the plug connector 76a returns to a posture as of before the force is applied to the plug connector 76a.

Additionally, in the rear cover 81, on a side portion on the +Z direction side, the cable holding portions 69a and 69b are formed, and on a side portion on the −Z direction side, the cable holding portions 71a and 71b are formed as shown in FIG. 11. The cable holding portion 69a is located on the −X direction side to support the cable 83a together with the cable holding portion 99a of the front cover 79 (see FIG. 12). The cable holding portion 69b is located on the +X direction side to support the cable 83b together with the cable holding portion 99b of the front cover 79 (see FIG. 12). The cable holding portion 71a is located on the −X direction side to hold the cable 84a together with the cable holding portion 100a of the front cover 79 (see FIG. 12). The cable holding portion 71b is located on the +X direction side to hold the cable 84b together with the cable holding portion 100b (see FIG. 12). The cable holding portions 69a, 69b, 71a, and 71b function as the second holding portions which hold the cables 83a, 83b, 84a, and 84b, together with the cable holding portions 99a, 99b, 100a, and 100b of the front cover 79 respectively.

In the second embodiment, the cable 83a (see FIG. 11) has a flexible portion which follows movement of the plug connector 76a, the flexible portion being housed in the cable housing portion 97a (see FIG. 12) between the circuit board 82a (see FIG. 11) as the first holding portion and the cable holding portion 99a (see FIG. 12) and the cable holding portion 69a (see FIG. 11) as the second holding portions. The circuit board 82a is fixed to the plug connector 76a and functions as the first holding portion which holds one end of the cable 83a as a flexible portion. The cable holding portion 99a of the front cover 79 and the cable holding portion 69a of the rear cover 81 are provided at the front cover 79 and the rear cover 81 as the covers, respectively, and function as the second holding portions which hold the other ends of the cables 83a as the flexible portion.

Provision of the flexible portion, the first holding portion and the second holding portion allows the plug connector 76a to move relative to the front cover 79 and the rear cover 81 without being restricted by other member. The flexible portion need not necessarily to be the cable 83a and can be the contact 85a of the plug connector 76a, for example. Additionally, the first holding portion need not to be the circuit board 82a and can be the plug connector 76a, for example.

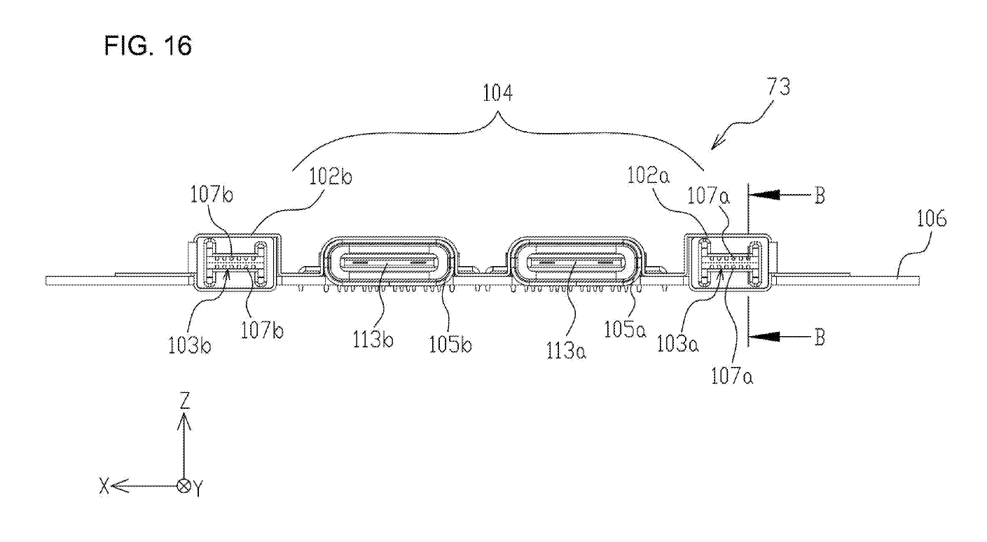

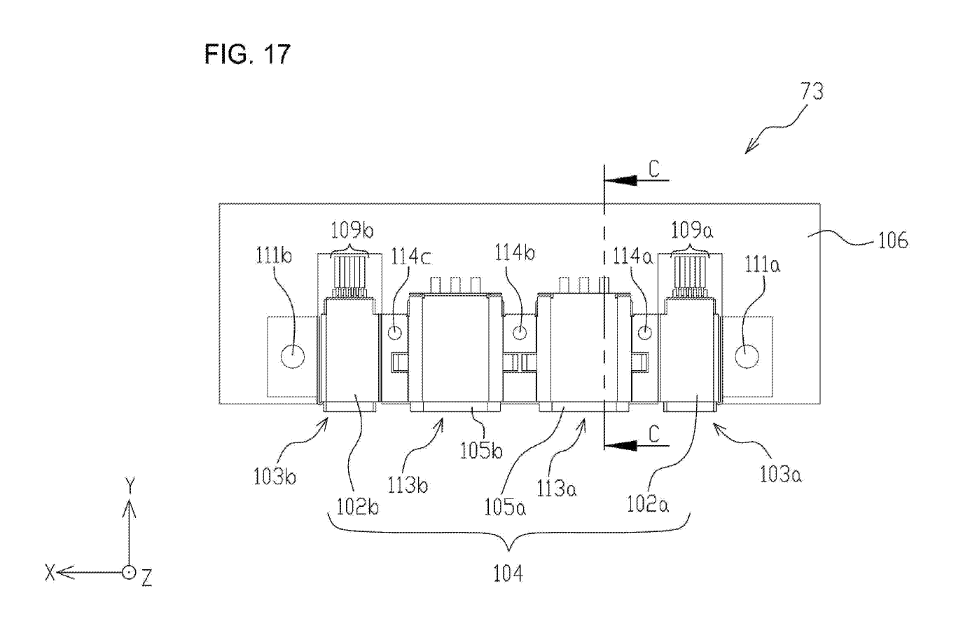

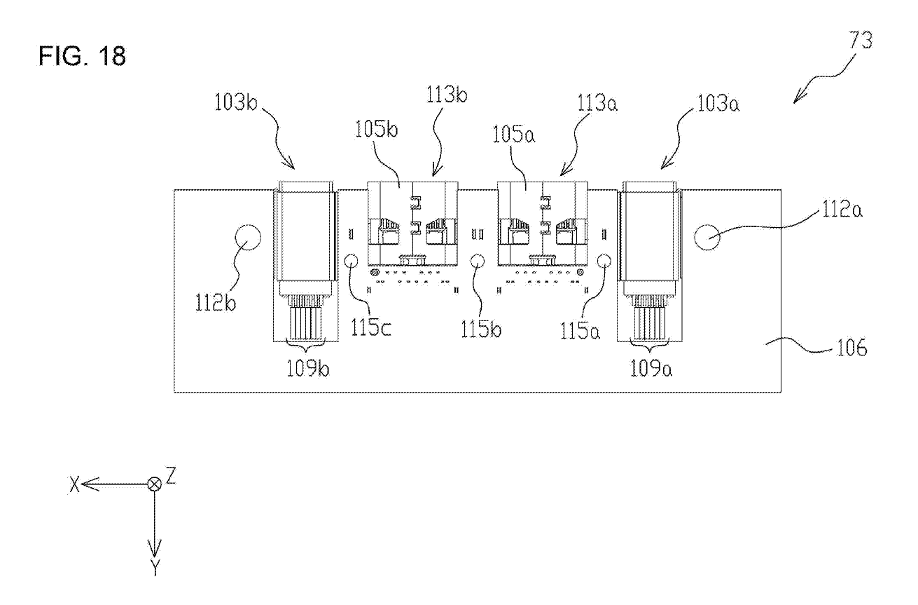

Next, description will be made of a docking connector on a receptacle side (hereinafter, referred to as a receptacle docking connector) as a receptacle unit according to the second embodiment of the present invention with reference to the drawings. FIG. 15 is a perspective view showing an appearance of a receptacle docking connector according to the second embodiment, FIG. 16 is a front view showing the appearance of the receptacle docking connector according to the second embodiment, FIG. 17 is a plan view showing the appearance of the receptacle docking connector according to the second embodiment, and FIG. 18 is a bottom plan view showing the appearance of the receptacle docking connector according to the second embodiment. The receptacle docking connector 73 is mounted on a portable terminal device (electronic apparatus) such as a tablet type PC or the like, and as shown in FIG. 15, includes a guide shell 104 having the two receptacle connectors 113a and 113b, the two additional receptacle connectors 103a and 103b, and the two guide reception portions 102a and 102b.

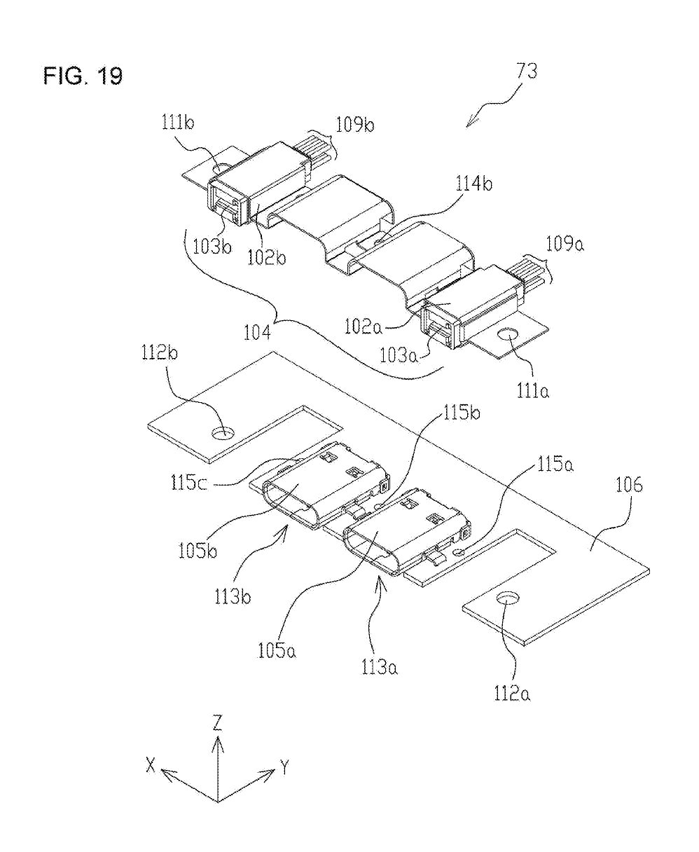

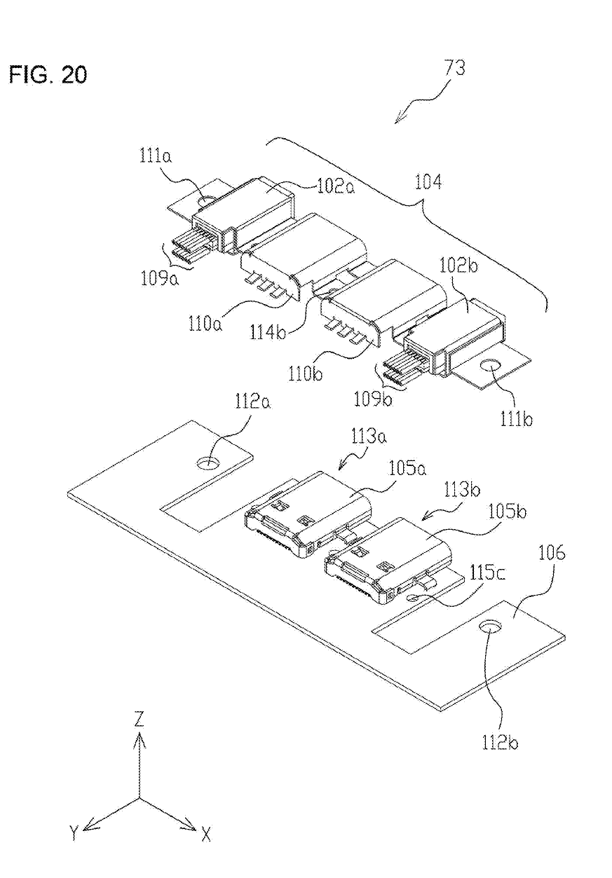

FIG. 19 and FIG. 20 are exploded views for explaining a configuration of the receptacle docking connector 73, FIG. 19 as a perspective view seen from the front side and FIG. 20 as a perspective view seen from the back side. The receptacle connector 113a includes a receptacle shell 105a which engages with the plug connector 76a (see FIG. 9) and as shown in FIG. 16, covers a contact and the like (not shown) provided in the receptacle connector 113a. The receptacle connector 113b includes a receptacle shell 105b which engages with the plug connector 76b (see FIG. 9) and as shown in FIG. 16, covers a contact and the like (not shown) provided in the receptacle connector 113b.

The receptacle connectors 113a and 113b are mounted on a mounting surface (a surface on the +Z direction side) of a board 106 such that an engagement direction (Y direction) as a direction of engagement with the plug connectors 76a and 76b and the mounting surface are parallel to each other. Additionally, the receptacle connectors 113a and 113b are mounted on the board 106 individually. Specifically, the receptacle connector 113a is mounted on the board 106 independently of the receptacle connector 113b. Although in the second embodiment, the two receptacle connectors 113a and 113b are provided, three or more receptacle connectors can be provided. Additionally, when three or more receptacle connectors are provided, at least one receptacle connector of the three or more receptacle connectors is mounted on the board 106 independently of at least one other receptacle connector. For example, when three receptacle connectors are provided, each receptacle connector is individually mounted on the board 106, or two receptacle connectors are integrally mounted on the board 106 and one receptacle connector is mounted on the board 106 independently of the other two receptacle connectors.

The additional receptacle connector 103a is located on the −X direction side of the receptacle docking connector 73 and is arranged within the guide reception portion 102a as shown in FIG. 15. FIG. 21 is a sectional view taken along B-B in FIG. 16. The additional receptacle connector 103a includes a plurality (12 in the second embodiment) of contacts 107a as shown in FIG. 16 and FIG. 21. At one end portion of the contact 107a, the connection terminal 108a as an elastic body is formed which connects with the contact 116a and a contact not shown of the additional plug connector 77a, as shown in FIG. 21. The other end portion of the contact 107a is electrically connected with a wire 109a as shown in FIG. 21.

The additional receptacle connector 103b is located on the +X direction side of the receptacle docking connector 73 and is arranged within the guide reception portion 102b as shown in FIG. 15. The additional receptacle connector 103b includes a plurality (12 in the second embodiment) of contacts 107b. At one end portion of the contact 107b, a connection terminal (not shown) as an elastic body is formed which connects with the contact 116b and a contact not shown of the additional plug connector 77b similarly to the contact 107a of the additional receptacle connector 103a. The other end portion of the contact 107b is electrically connected with a wire 109b.

In the above second embodiment, description has been made of a case where the plug connector 76a is engaged with the receptacle connector 113a and the plug connector 76b is engaged with the receptacle connector 113b. In this case, the additional receptacle connector 103a engages with the additional plug connector 77a, and the additional receptacle connector 103b engages with the additional plug connector 77b. However, the plug docking connector 75 and the receptacle docking connector 73 according to the second embodiment are reversible connectors, and also the receptacle connector 113a can be engaged with the plug connector 76b and the receptacle connector 113b can be engaged with the plug connector 76a. In this case, the additional receptacle connector 103a and the additional plug connector 77b engage with each other and the additional receptacle connector 103b engages with the additional plug connector 77a.

Next, a configuration of the guide shell 104 will be described. The guide shell 104 is formed of metal or the like and includes the guide reception portion 102a and the additional receptacle connector 103a arranged in the −X direction side, and the guide reception portion 102b and the additional receptacle connector 103b arranged in the +X direction side. Specifically, the guide reception portions 102a and 102b integrally formed. As shown in FIG. 15, the guide shell 104 covers outer circumferences on the +Z direction side of the receptacle connectors 113a and 113b.

Additionally, as shown in FIG. 20, the guide shell 104 includes supporting portions 110a and 110b which support the receptacle connectors 113a and 113b in the insertion direction (the +Y direction) in which the guide portions 78a and 78b (see FIG. 9) are inserted into the guide reception portions 102a and 102b. As shown in FIG. 20, the guide shell 104 (the supporting portions 110a and 110b) covers the outer circumferences on the +Y direction side of the receptacle connectors 113a and 113b. The supporting portions 110a and 110b receive a force applied to the +Y direction when the guide portions 78a and 78b are inserted into the guide reception portions 102a and 102b. Additionally, the supporting portions 110a and 110b prevent coming-off of the receptacle connectors 113a and 113b from the board 106.

Additionally, the guide shell 104 is provided with a hole 111a for allowing a screw to pass to the −X direction side in the vicinity of the additional receptacle connector 103a, and a hole 111b for allowing a screw to pass to the +X direction side in the vicinity of the additional receptacle connector 103b. Additionally, the guide shell 104 is provided with a hole 114a for allowing a screw to be inserted between the additional receptacle connector 103a and the receptacle connector 113a, a hole 114b for allowing a screw to be inserted between the receptacle connector 113a and the receptacle connector 113b, and a hole 114c for allowing a screw to be inserted between the receptacle connector 113b and the additional receptacle connector 103b. The holes 111a, 111b, and 114a to 114c function as fixing portions for fixing the guide shell 104 to a casing of a portable terminal device. The guide shell 104 and the board 106 are screwed to the casing (not shown) of the portable terminal device by inserting a screw into the hole 111a and a hole 112a formed in the board 106, inserting a screw into the hole 111b and a hole 112b formed in the board 106, inserting a screw into the hole 114a and a hole 115a formed in the board 106, inserting a screw into the hole 114b and a hole 115b formed in the board 106, and inserting a screw into the hole 114c and a hole 115c formed in the board 106. Specifically, the guide shell 104 is fixed to the casing together with the board 106 after the receptacle connectors 113a and 113b are mounted on the board 106. At this time, the guide shell 104 is attached to the casing of the portable terminal device from a position (the +Z direction side) opposed to the mounting surface (the surface on the +Z direction side) of the board 106.

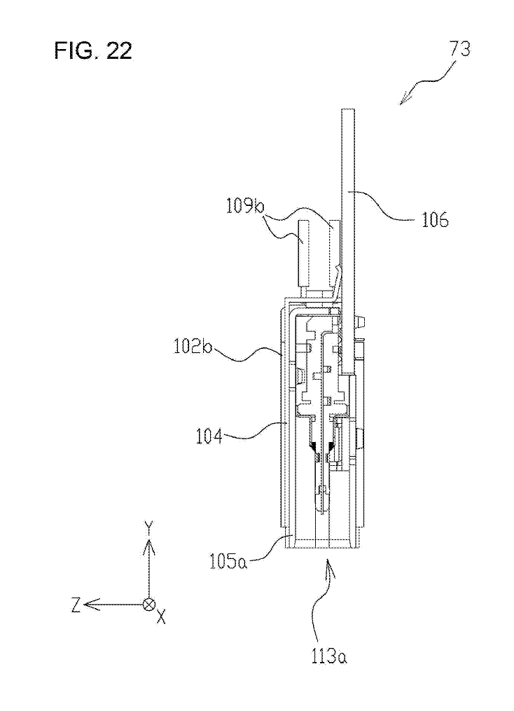

FIG. 22 is a sectional view taken along C-C in FIG. 17. The guide shell 104 and the receptacle shell 105a of the receptacle connector 113a electrically conduct with each other as shown in FIG. 22. Similarly, the guide shell 104 and the receptacle shell 105b of the receptacle connector 113b electrically conduct with each other.

With the plug docking connector 75 according to the second embodiment provided with the guide portions 78a and 78b, the guide portions 78a and 78b are inserted into the guide reception portions 102a and 102b of the receptacle docking connector 73 before the plug connectors 76a and 76b engage with the receptacle connectors 113a and 113b. Accordingly, the plug connectors 76a and 76b can be securely engaged with the receptacle connectors 113a and 113b without damages.

Additionally, with the plug docking connector 75 according to the second embodiment provided with the control portions 89a and 89b, the plug connectors 76a and 76b are connected with the cables 83a, 83b, 84a, and 84b (flexible portions) via the circuit boards 82a and 82b, and the flexible portion is held by the first holding portion and the second holding portion. Accordingly, the positions and the postures of the plug connectors 76a and 76b can be controlled. Specifically, since the plug connectors 76a and 76b are configured to be movable within a predetermined space, a tolerance can be minimized and the plug connectors 76a and 76b can be securely engaged with the receptacle connectors 113a and 113b without damages. Additionally, when not engaged with the receptacle connectors 113a and 113b, the plug connectors 76a and 76b can be maintained at a predetermined position and in a predetermined posture by position control and posture control by the control portions 89a and 89b. Specifically, deviation in a position and a posture of the plug connectors 76a and 76b at the time of mounting can be securely absorbed.

Additionally, with the receptacle docking connector 73 according to the second embodiment provided with the guide reception portions 102a and 102b, the guide portions 78a and 78b are inserted into the guide reception portions 102a and 102b before the plug connectors 76a and 76b engage with the receptacle connectors 113a and 113b. Accordingly, the plug connectors 76a and 76b can be securely engaged with the receptacle connectors 113a and 113b without damages.

Additionally, with the receptacle docking connector 73 according to the second embodiment, the receptacle connectors 113a and 113b are individually mounted on the board 106 and thereafter, at the time of attaching the board 106 to the casing of the portable terminal device, the guide shell 104 is attached together with the board 106. Accordingly, flatness (coplanarity) of the receptacle docking connector 73 with respect to the mounting surface of the board 106 can be excellently maintained to prevent a soldering failure due to poor flatness.

Additionally, with the receptacle docking connector 73 according to the second embodiment, the guide shell 104 covers the receptacle connectors 113a and 113b, and the guide shell 104 and the receptacle shells 105a and 105b electrically conduct with each other. Accordingly, while the receptacle shells 105a and 105b function as inner shells of the receptacle connectors 113a and 113b, the guide shell 104 is allowed to function as an outer shell of the receptacle connectors 113a and 113b. Additionally, since the guide shell 104 covers the receptacle connectors 113a and 113b, and is fixed to the board 106, coming-off of the receptacle connectors 113a and 113b from the board 106 must be prevented.

Additionally, although when a connector is further added to a docking connector having predetermined standard connectors such as a plurality of connectors conforming to the standard specification, there occurs a problem of increasing the docking connector in size, the plug docking connector 75 according to the second embodiment enables down-sizing thereof because the additional plug connectors 77a and 77b are arranged in the guide portions 78a and 78b. Similarly, the receptacle docking connector 73 according to the second embodiment enables down-sizing thereof because the additional receptacle connectors 103a and 103b are arranged in the guide reception portions 102a and 102b.

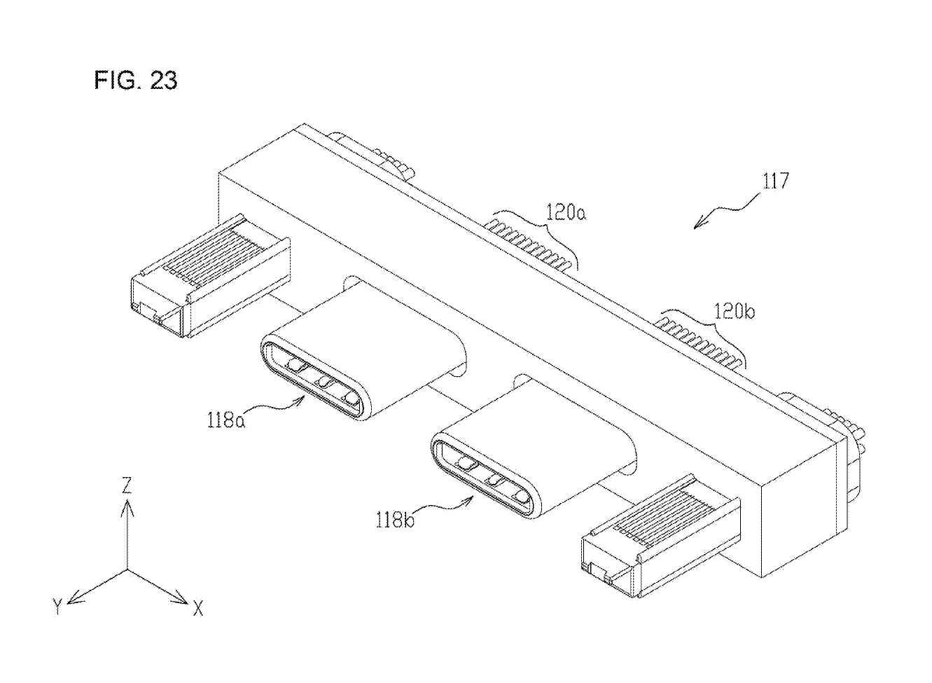

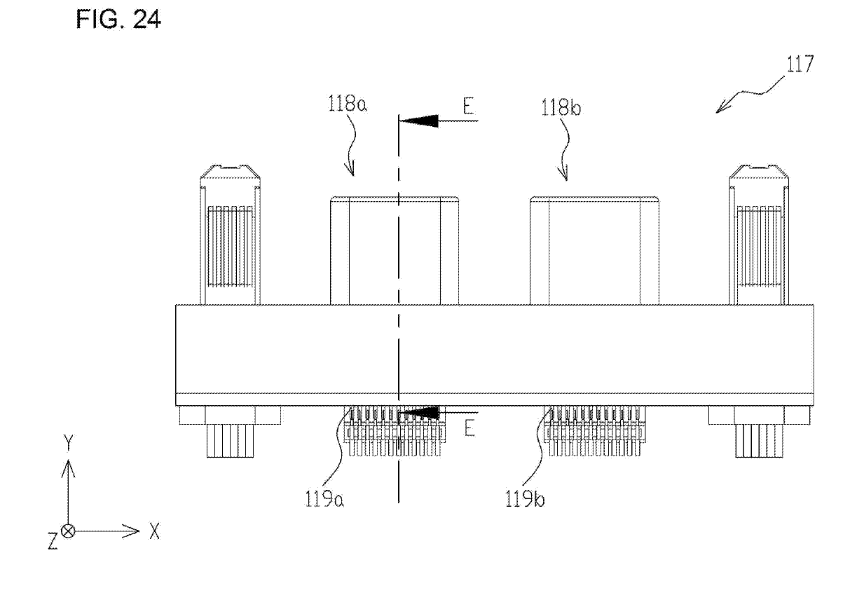

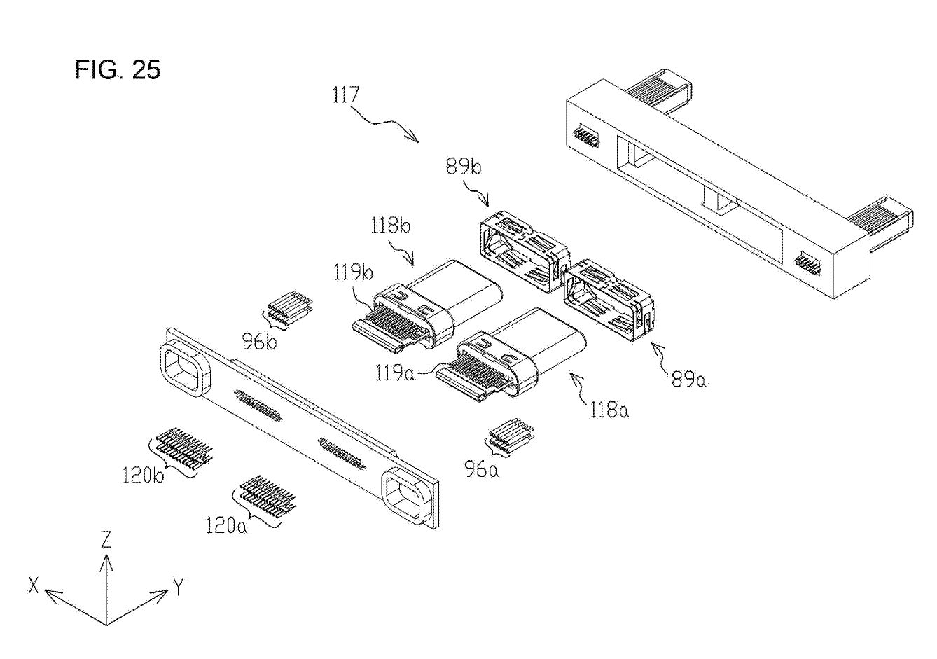

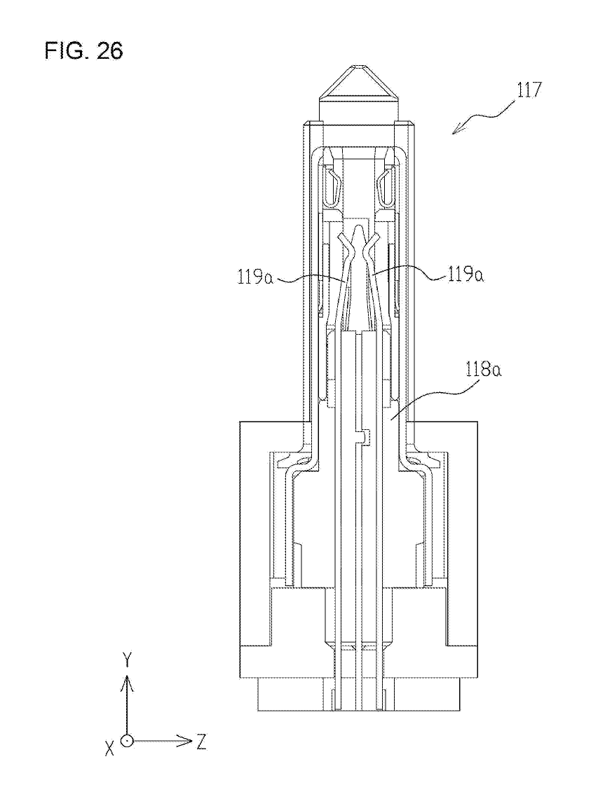

In the above plug docking connector 75 according to the second embodiment, the plug connectors 76a and 76b are mounted on the circuit boards 82a and 82b, and the contacts 85a, 59a, and 85b of the plug connectors 76a and 76b, and the cables 83a, 83b, 84a, and 84b are electrically connected with each other via the circuit boards 82a and 82b. However, in place of such a configuration, for example, a plug docking connector 117 as shown in FIG. 23 can be used. FIG. 23 is a perspective view showing an appearance of the plug docking connector 117, FIG. 24 is a bottom plan view showing the appearance of the plug docking connector 117, FIG. 25 is an exploded view showing a configuration of the plug docking connector 117, and FIG. 26 is a sectional view taken along E-E in FIG. 24.

As shown in FIG. 25 and FIG. 26, plug connectors 118a and 118b configuring the plug docking connector 117 are not mounted on the circuit board, and a plurality of contacts 119a and 119b of the plug connectors 118a and 118b and the cables 120a and 120b are directly connected by soldering or the like. Even when the plug docking connector 117 is mounted on an electronic apparatus or the like and a position relative to a printed board mounted on the electronic apparatus differs, connection with the printed board can be realized with ease without changing a shape or a length of the plurality of contacts 119a and 119b of the plug connectors 118a and 118b. Specifically, since the contacts 119a and 119b are connected with the cables 120a and 120b, connection of the cables 120a and 120b with the printed board of the electronic apparatus enables electrical connection of the plug connectors 118a and 118b with the printed board via the cables 120a and 120b.

Additionally, although in the above plug docking connector 75 according to the second embodiment, the control portion 89a controls a position and a posture of the plug connector 76a, and the control portion 89b controls a position and a posture of the plug connector 76b, the plug docking connector can be configured to include only the control portion 89a, or only the control portion 89b. When only the control portion 89a (or 89b) is provided, a position and a posture of the plug connector 76b (or 76a) are defined in advance, and only a position and a posture of the plug connector 76a (or 76b) are controlled.

Additionally, although in the above plug docking connector 75 according to the second embodiment, the control portions 89a and 89b control the postures of the plug connectors 76a and 76b by using the Y side elastic portion 94a and the convex portions 67a and 67b of the rear cover 81, a posture control portion having an elastic portion and a convex portion can be provided between the circuit boards 82a and 82b and the rear cover 81, so that the posture control portion controls the postures of the plug connectors 76a and 76b.

Additionally, although in the above receptacle docking connector 73 according to the second embodiment, as shown in FIG. 21, the other end portions of the contacts 107a and 107b are electrically connected with the wires 109a and 109b, in place of such a configuration, a second engagement portion can be provided which engages with a connector mounted on the board 106 in advance other than a first engagement portion in which the additional receptacle connectors 103a and 103b engage with the additional plug connectors 77a and 77b. In this case, one end portions of the contacts 107a and 107b electrically connect with the contacts 116a and 116b and contacts not shown of the additional plug connectors 77a and 77b, and the other end portions of the contacts 107a and 107b electrically connect with contacts of the connector mounted on the board 106 in advance.

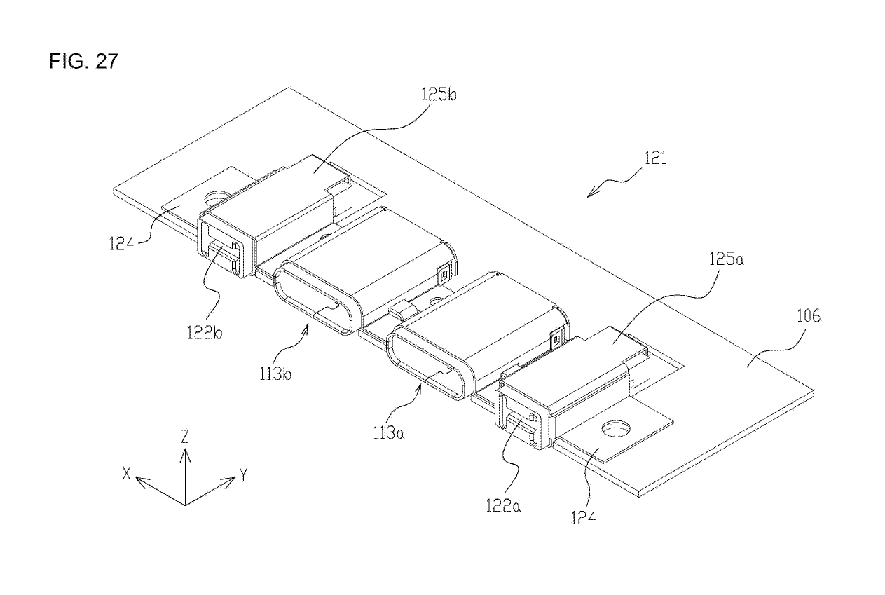

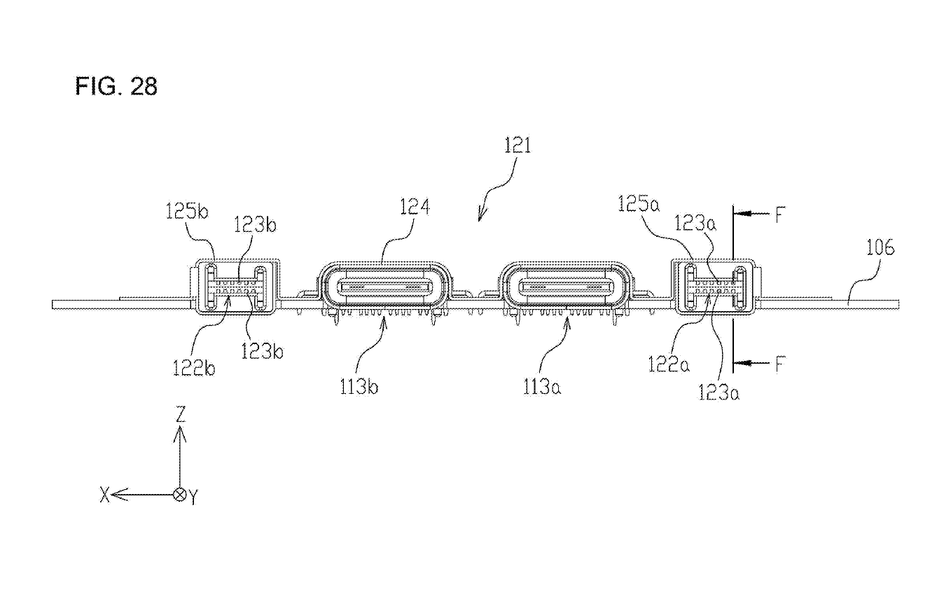

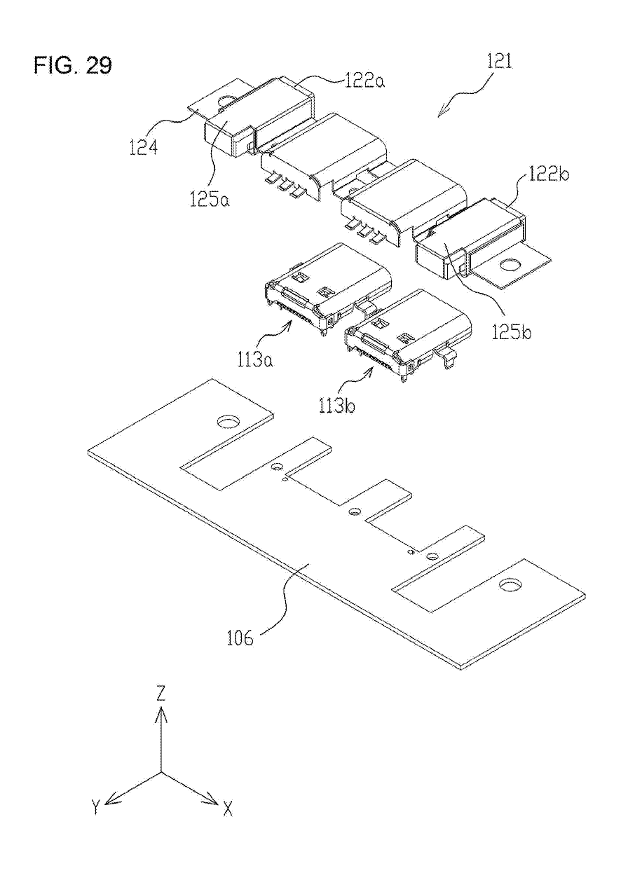

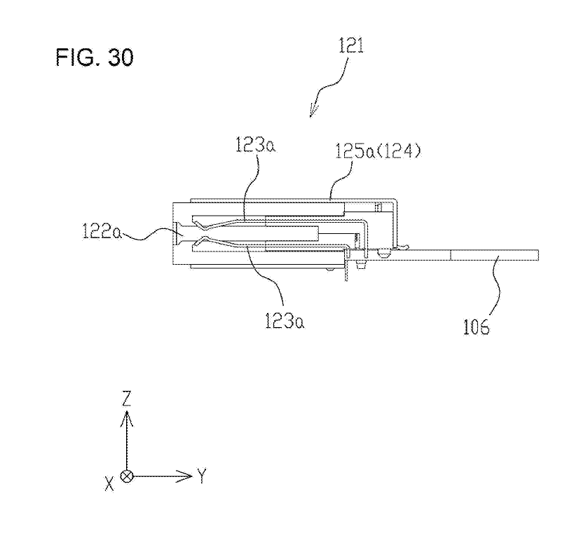

Additionally, although in the above receptacle docking connector 73 according to the second embodiment, as shown in FIG. 21, the other end portions of the contacts 107a and 107b are electrically connected with the wires 109a and 109b, in place of such a configuration, for example, a receptacle docking connector 121 can be used as shown in FIG. 27. FIG. 27 is a perspective view showing an appearance of the receptacle docking connector 121, FIG. 28 is a front view showing the appearance of the receptacle docking connector 121, FIG. 29 is an exploded view showing a configuration of the receptacle docking connector 121, and FIG. 30 is a sectional view taken along F-F in FIG. 28. As shown in FIG. 27 to FIG. 30, to contacts 123a and 123b of additional receptacle connectors 122a and 122b configuring the receptacle docking connector 121, no wire is connected. Additionally, a guide shell 124 configuring the receptacle docking connector 121 supports the additional receptacle connectors 122a and 122b in the insertion direction (the +Y direction) in which the guide portions of the plug docking connector are inserted into guide reception portions 125a and 125b.

Additionally, although the above receptacle docking connector 73 according to the second embodiment includes the two guide reception portions 102a and 102b, one guide reception portion, or three or more guide reception portions may be provided. Even when three or more guide reception portions are provided, the guide reception portions are formed integrally.

Additionally, although the receptacle docking connector 73 according to the second embodiment, which is a reversible connector, includes the two additional receptacle connectors 103a and 103b, one additional receptacle connector may be provided. In this case, when the plug connector 76a engages with the receptacle connector 113a, the additional plug connector 77a engages with the additional receptacle connector, and when the plug connector 76b engages with the receptacle connector 113b, the additional plug connector 77b engages with the additional receptacle connector.

Additionally, although in the above second embodiment, only the front end portions of the guide portions 78a and 78b protrude more than the front end portions of the plug connectors 76a and 76b, only front end portions of the guide reception portions 102a and 102b may protrude more than front end portions of the receptacle connectors 113a and 113b. Additionally, the front end portions of the guide portions 78a and 78b may protrude more than the front end portions of the plug connectors 76a and 76b, and the front end portions of the guide reception portions 102a and 102b may protrude more than the front end portions of the receptacle connectors 113a and 113b.

Although the above plug docking connectors according to the respective embodiments are each provided with two USB Type-C plug connectors, the plug docking connector may be provided with three or more USB Type-C plug connectors. Additionally, a USB Type-C plug connector may be replaced by other plurality of plug connectors conforming to the standard specification than a USB Type-C plug connector. Additionally, a plurality of predetermined standard plug connectors having a predetermined standard may be provided other than the plug connectors conforming to the standard specification.

Similarly, although the above receptacle docking connectors according to the respective embodiments are each provided with two USB Type-C receptacle connectors, the receptacle docking connector may be provided with three or more USB Type-C receptacle connectors. Additionally, a USB Type-C receptacle connector may be replaced by other plurality of receptacle connectors conforming to the standard specification than a USB Type-C receptacle connector. Additionally, a plurality of predetermined standard receptacle connectors having a predetermined standard may be provided other than the receptacle connectors conforming to the standard specification.

Additionally, although the above respective embodiments are configured such that a position and a posture of the plug connector are controlled, the embodiments may be configured such that only a position of the plug connector is controlled, or such that only a posture of the plug connector is controlled.

Additionally, although the above plug docking connectors according to the respective embodiments are each provided with two or four additional plug connectors, the plug docking connector may be provided with one, or three, or five or more additional plug connectors. Similarly, although the above receptacle docking connectors according to the respective embodiments are each provided with two or four additional receptacle connectors, the receptacle docking connector may be provided with one, or three, or five or more additional receptacle connectors.

The foregoing described embodiments are recited for facilitating understanding of the present invention and not to be construed as limiting the present invention. Accordingly, each element disclosed in the above embodiments intends to include all design changes and equivalents within a technical range of the present invention.

1. A receptacle unit including a plurality of receptacle connectors and mounted on an electronic apparatus, comprising
at least two guide reception portions which, when docking with a plug unit including a plurality of plug connectors, before at least one of the plurality of receptacle connectors engages with at least one of the plurality of plug connectors, receive a guide portion of the plug unit, and
a coupling portion which couples the at least two guide reception portions, wherein
at least one receptacle connector of the plurality of receptacle connectors is mounted on a board independently of at least one other of the receptacle connectors, and
the at least two guide reception portions and the coupling portion are fixed to the board after the plurality of receptacle connectors are mounted on the board.

2. The receptacle unit according to claim 1, comprising
a second additional connector arranged in the at least two guide reception portions, wherein
the second additional connector includes a second contact, one end portion of the second contact being electrically connected with a first contact of a first additional connector included in the plug unit, and the other end portion of the second contact being electrically connected with a wire.

3. The receptacle unit according to claim 1, comprising
a second additional connector arranged in the at least two guide reception portions, wherein
the second additional connector includes a second contact, one end portion of the second contact being electrically connected with a first contact of a first additional connector included in the plug unit, and the other end portion of the second contact being electrically connected with a contact of a connector mounted on the board.

4. The receptacle unit according to claim 1, wherein
the at least two guide reception portions and a shell of at least one receptacle connector of the plurality of receptacle connectors electrically conduct with each other.

5. The receptacle unit according to claim 2, wherein
the at least two guide reception portions include a fixing portion to be fixed to the board,
the fixing portion being arranged in a vicinity of the second additional connector and between the plurality of receptacle connectors.

6. The receptacle unit according to claim 1, wherein the at least two guide reception portions are fixed to a casing of the electronic apparatus together with the board.

7. The receptacle unit according to claim 1, wherein the plurality of receptacle connectors are mounted on a mounting surface of the board such that an engagement direction of engagement with the plurality of plug connectors is parallel to the mounting surface, and
the at least two guide reception portions are fixed to the board from a position opposed to the mounting surface.

8. The receptacle unit according to claim 1, wherein the at least two guide reception portions support the plurality of receptacle connectors in an insertion direction in which the guide portion of the plug unit is inserted into the at least two guide reception portions.

9. The receptacle unit according to claim 1, wherein at least one of the plurality of receptacle connectors is of USB Type-C.

10. A receptacle unit including a plurality of receptacle connectors and mounted on an electronic apparatus, comprising
at least one guide reception portion which, when docking with a plug unit including a plurality of plug connectors, before at least one of the plurality of receptacle connectors engages with at least one of the plurality of plug connectors, receives a guide portion of the plug unit, and
a guide shell covers the plurality of receptacle connectors, wherein
at least one receptacle connector of the plurality of receptacle connectors is mounted on a board independently of at least one other of the receptacle connectors, and
the guide shell is fixed to the board after the plurality of receptacle connectors are mounted on the board.

11. The receptacle unit according to claim 10, comprising
a second additional connector arranged in the guide reception portion, wherein
the second additional connector includes a second contact, one end portion of the second contact being electrically connected with a first contact of a first additional connector included in the plug unit, and the other end portion of the second contact being electrically connected with a wire.

12. The receptacle unit according to claim 10, comprising
a second additional connector arranged in the guide reception portion, wherein
the second additional connector includes a second contact, one end portion of the second contact being electrically connected with a first contact of a first additional connector included in the plug unit, and the other end portion of the second contact being electrically connected with a contact of a connector mounted on the board.

13. The receptacle unit according to claim 10, wherein
the guide reception portion and a shell of at least one receptacle connector of the plurality of receptacle connectors electrically conduct with each other.

14. The receptacle unit according to claim 11, wherein
the guide reception portion includes a fixing portion to be fixed to the board,
the fixing portion being arranged in a vicinity of the second additional connector and between the plurality of receptacle connectors.

15. The receptacle unit according to claim 10, wherein the guide reception portion is fixed to a casing of the electronic apparatus together with the board.

16. The receptacle unit according to claim 10, wherein the plurality of receptacle connectors are mounted on a mounting surface of the board such that an engagement direction of engagement with the plurality of plug connectors is parallel to the mounting surface, and
the guide reception portion is fixed to the board from a position opposed to the mounting surface.

17. The receptacle unit according to claim 10, wherein the guide reception portion supports the plurality of receptacle connectors in an insertion direction in which the guide portion of the plug unit is inserted into the guide reception portion.

18. The receptacle unit according to claim 10, wherein at least one of the plurality of receptacle connectors is of USB Type-C.
